(19) United States
(12) Patent Application Publication
(10) Pub. No.: US 2023/0017527 A1
(43) Pub. Date: Jan. 19, 2023

(54) TERMINAL DEVICE, MANAGEMENT DEVICE, AND COMMUNICATION METHOD

(71) Applicant: SONY GROUP CORPORATION, TOKYO (JP)

(72) Inventor: SHINICHIRO TSUDA, TOKYO (JP)

(21) Appl. No.: 17/757,504

(22) PCT Filed: Dec. 21, 2020
(86) PCT No.: PCT/JP2020/047778

§ 371 Date: Jun. 16, 2022

(30) Foreign Application Priority Data
Dec. 26, 2019 (JP) 2019-237384

(51) Int. Cl. H04W 8/24; H04W 8/08; H04W 16/28; H04W 28/24

(52) U.S. Cl. CPC H04W 8/24; H04W 8/08; H04W 16/28; H04W 28/24

(57) ABSTRACT

A terminal device (40) includes a control unit (45). The control unit (45) acquires service information about one or more services provided via a base station apparatus (20). The control unit (45) selects at least one service desired to be used, from among one or more services. The control unit (45) transmits a registration request message including the service selected, to a management device (10A) managing mobility of the terminal device (40) via the base station apparatus (20). The control unit (45) receives, for each service included in the registration request message, reference information about an operating environment of the terminal device (40) requested upon using the service.

### FIELD

The present disclosure relates to a terminal device, a management device, and a communication method.

### BACKGROUND

A radio access system and a wireless network for cellular mobile communication (hereinafter, also referred to as “Long Term Evolution (LTE)”, “LTE-Advanced (LTE-A)”, “LTE-Advanced Pro (LTE-A Pro)”, “New Radio (NR)”, “New Radio Access Technology (NRAT)”, “Evolved Universal Terrestrial Radio Access (EUTRA)”, or “Further EUTRA (FEUTRA)”) are considered in 3rd Generation Partnership Project (3GPP). Note that, in the following description, LTE includes LTE-A, LTE-A Pro, and EUTRA, and NR includes NRAT and FEUTRA. A base station apparatus (base station, and communication apparatus) is also referred to as evolved NodeB (eNodeB) in LTE and gNodeB in NR, and a terminal device (mobile station, mobile station apparatus, terminal, or communication device) is also referred to as User Equipment (UE) in LTE and NR. LTE and NR are cellular communication systems in which a plurality of areas covered by the base station apparatuses is arranged in cells. Note that a single base station apparatus may manage a plurality of cells.

NR has characteristics of ultra-high speed, low latency, high reliability, and multiple simultaneous connections. As one of use cases of NR utilizing such characteristics, for example, utilization in services using Augmented Reality (AR) and Virtual Reality (VR) has been considered. For example, use of the AR technology makes it possible to superimpose virtual content of various modes such as text, an icon, or animation on a real object captured in an image in a real space and present the virtual content to the user. Non Patent Literature 1 and Non Patent Literature 2 disclose the use cases of and (latent) requirements for services (e.g., AR/VR games) using the Augmented Reality (AR) and Virtual Reality (VR).

### CITATION LIST

### Non Patent Literature

Non Patent Literature 1: 3GPP TR 22.842, V17.1.0 (2019 September) 3rd Generation Partnership Project; Technical Specification Group Services and System Aspects; Study on Network Controlled Interactive Services (Release 17)
Non Patent Literature 2: 3GPP TS 22.261 v17.0.1 (2019 October) 3rd Generation Partnership Project; Technical Specification Group Services and System Aspects; Service requirements for next generation new services and markets (Release 17)

### SUMMARY

### Technical Problem

For example, in a case where a game service is provided wirelessly, there is a problem that it is difficult to provide a stable quality service from the viewpoint of latency and throughput. For example, in wireless communication, there are limitations such as radio resources and the number of terminals that can be connected at the same time, and it is desired to provide the stable quality service even in these finite capacities. In addition, it is also difficult for a terminal device that receives the provision of the service to receive the stable quality service due to limitations in the capability and mobility of the terminal device, in some cases.

Therefore, the present disclosure proposes a technology that contributes to achievement of provision of a more stable quality service.

Note that the above problems or object is merely one of a plurality of problems or objects that can be solved or achieved by a plurality of embodiments disclosed herein.

### Solution to Problem

According to the present disclosure, a terminal device is provided. The terminal device includes a control unit. The control unit acquires service information about one or more services provided via a base station apparatus. The control unit selects at least one service desired to be used, from among one or more services. The control unit transmits a registration request message including the service selected, to a management device managing mobility of the terminal device via the base station apparatus. The control unit receives, for each service included in the registration request message, reference information about an operating environment of the terminal device requested upon using the service.

### BRIEF DESCRIPTION OF DRAWINGS

FIG. 1 is a diagram illustrating the overview of a communication process performed by a communication system according to an embodiment of the present disclosure.

FIG. 2 is a diagram illustrating the overview of a communication process performed by the communication system according to an embodiment of the present disclosure.

FIG. 3 is a diagram illustrating an example of a 5G architecture.

FIG. 4 is a table illustrating SST values standardized by 3GPP TS 23.501.

FIG. 5 is a diagram illustrating a configuration example of the communication system according to an embodiment of the present disclosure.

FIG. 6 is a block diagram illustrating a configuration example of a first management device according to an embodiment of the present disclosure.

FIG. 7 is a table illustrating an example of a reference information DB according to an embodiment of the present disclosure.

FIG. 8 is a table illustrating another example of the reference information DB according to an embodiment of the present disclosure.

FIG. 9 is a block diagram illustrating a configuration example of a second management device according to an embodiment of the present disclosure.

FIG. 10 is a block diagram illustrating a configuration example of a third management device according to an embodiment of the present disclosure.

FIG. 11 is a table illustrating an example of QoSDB according to an embodiment of the present disclosure.

FIG. 12 is a block diagram illustrating a configuration example of a base station apparatus according to an embodiment of the present disclosure.

FIG. 13 is a diagram illustrating a configuration example of a terminal device according to an embodiment of the present disclosure.

FIG. 14 is a sequence diagram illustrating a procedure of a registration process according to an embodiment of the present disclosure.

FIG. 15 is a sequence diagram illustrating an example of a PDU session establishment process in the communication system of the present disclosure.

FIG. 16 is a flowchart illustrating an example of an establishment determination process in the first management device according to the embodiment of the present disclosure.

FIG. 17 is a sequence diagram illustrating another example of the PDU session establishment process according to an embodiment of the present disclosure.

### DESCRIPTION OF EMBODIMENTS

Preferred embodiments of the present disclosure will be described in detail below with reference to the accompanying drawings. Note that in the present description and the drawings, component elements having substantially the same functional configurations are designated by the same reference numerals and symbols, and redundant description thereof will be omitted.

Note that the description will be given in the following order.

1. Overview of communication system

2. Configuration of communication system

2.1. Configuration example of network architecture

2.2 Configuration example of communication system

2.2.1. Configuration example of first management device 10A

2.2.2. Configuration example of second management device 10B

2.2.3. Configuration example of third management device 10C

2.2.4. Configuration example of base station apparatus

2.2.5. Configuration example of terminal device

3. Operations of communication system

3.1. Registration process

3.2. PDU session establishment process

4. Other embodiments

5. Supplementary notes

### 1. Overview of Communication System

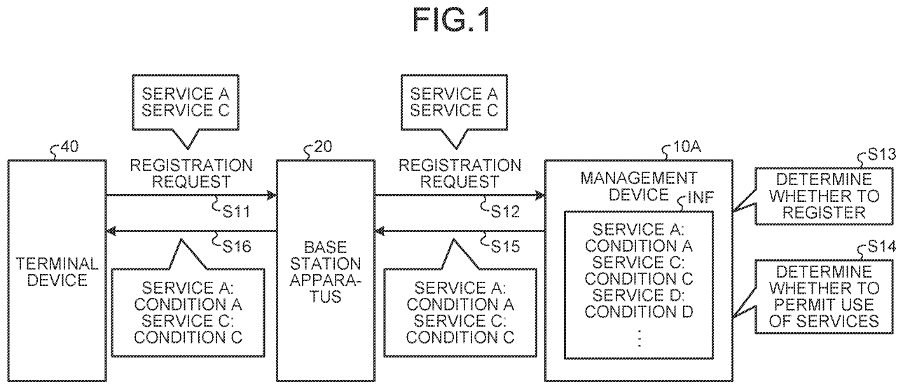

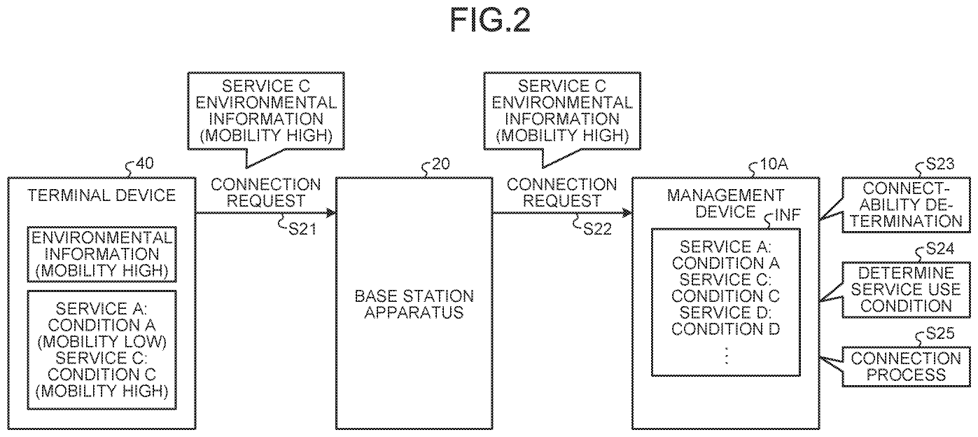

The overview of a communication system according to an embodiment of the present disclosure will be described with reference to FIGS. 1 and 2. FIGS. 1 and 2 are diagrams each illustrating the overview of a communication process performed by the communication system according to the embodiment of the present disclosure.

The communication system according to the embodiment of the present disclosure includes a management device 10A, a base station apparatus 20, and a terminal device 40. The management device 10A manages, for example, mobility of the terminal device 40. The terminal device 40 is connected to a core network including the management device 10A via the base station apparatus 20 and receives provision of one or more services.

The terminal device 40 first performs a registration process for registration on a Serving Public Land Mobile Network (PLMN) illustrated in FIG. 1, for example, upon activation or the like, and then performs a connection process illustrated in FIG. 2 when actually using service provision.

(Overview of Registration Process)

First, the overview of the registration process will be described with reference to FIG. 1.

The terminal device 40 first of all acquires service information about the one or more services, in the registration process for registration on the Serving PLMN. For example, in a case where each service supports 5G network slicing, the service information is indicated by Configured Network Slice Selection Assistance Information (NSSAI) or Allowed NSSAI. An example of the 5G network slicing will be described below.

The terminal device 40 selects a service desired to be registered, on the basis of the acquired service information, and transmits a registration request including information about the selected service to the base station apparatus 20 (Step S11). In the example of FIG. 1, the terminal device 40 selects a service A and a service C, and transmits a registration request message.

For example, in 5G, a network slice is identified by S-NSSAI. In the example of FIG. 1, the terminal device 40 transmits a message including Requested NSSAI (including the S-NSSAI corresponding to the selected service A and service C) to the base station apparatus 20, thereby transmitting the registration request including information (here, the S-NSSAI) about the services. More specifically, the terminal device 40 transmits an AN message including Registration Request and AN parameters to the base station apparatus 20.

Upon receiving the message (e.g., the AN message) including the registration request, the base station apparatus 20 selects the management device 10A that is suitable for the services, on the basis of the information about the services included in the message. For example, the base station apparatus 20 selects the management device 10A, on the basis of the Requested NSSAI included in the AN parameters of the AN message. The base station apparatus 20 transfers the registration request to the selected management device 10A (Step S12).

The management device 10A determines whether to register the terminal device 40 on the basis of the registration request (Step S13). In a case where the registration of the terminal device 40 is permitted, the management device 10A determines whether to permit use registration for the services included in the registration request (Step S14). The management device 10A stores, for example, service subscription information INF (Subscribed S-NSSAI) for each terminal device 40, and determines whether to permit use of the services, on the basis of the subscription information INF. In the example of FIG. 1, the terminal device 40 has a service subscription for the service A and the service C, and thus the management device 10A permits the terminal device 40 to register the service A and the service C.

The management device 10A transmits registration permission (e.g., Allowed NSSAI) including the service A and the service C for which registration is to be permitted, to the base station apparatus 20 (Step S15). Here, the registration permission includes, in addition to the services, reference information (condition) about an operating environment required to use each of such services.

For example, in a case where the service A desired to be used by the terminal device 40 is a service that requires high-speed and large-capacity communication, there is a possibility that communication cannot be ensured and the service cannot be appropriately provided due to a high outdoor mobility.

As described above, the operating environment of the terminal device 40 necessary to provide an appropriate service changes depending on the service. Therefore, the management device 10A stores the reference information (condition) about the operating environment necessary for each service, and transmits the registration permission including the services to be permitted and the reference information, to the base station apparatus 20. The base station apparatus 20 transfers the registration permission including the services to be permitted and the reference information to the terminal device 40 (Step S16).

Therefore, the registration process for registration of the terminal device 40 on the Serving PLMN is completed.

Next, the connection process (PDU session establishment request) performed by the terminal device 40 when using the service will be described with reference to FIG. 2.

As illustrated in FIG. 2, the terminal device 40 stores the reference information (condition) acquired in the registration process for the service for which registration is permitted. The terminal device 40 determines whether environmental information about the operating environment of the terminal device 40 itself satisfies the reference information of the service desired to be used, and transmits a connection request including information about the service satisfying the reference information (e.g., S-NSSAI) to the base station apparatus 20 (Step S21). At this time, the terminal device 40 transmits the connection request (the PDU session establishment request) including the environmental information of the terminal device 40 itself.

In the example of FIG. 2, when using the service C, the terminal device 40 determines that the environmental information (mobility high) of the terminal device 40 itself satisfies the reference information (condition C) of the service C, and transmits the connection request including the service C and the environmental information (mobility high) to the base station apparatus 20.

The base station apparatus 20 transfers the connection request to the management device 10A (Step S22). Upon receiving the connection request from the terminal device 40, the management device 10A performs connectability determination for whether to permit connection (Step S23). When permitting the connection of the terminal device 40, the management device 10A performs service use condition determination for whether the operating environment of the terminal device 40 satisfies the condition C of the service C to be used (Step S24). In the example of FIG. 2, the condition C of the service C indicates “mobility high”, and the operating environment of the terminal device 40 satisfies the condition of “mobility high” as well. In this case, the management device 10A performs subsequent connection process, assuming that the operating environment of the terminal device 40 satisfies the condition of the service C (Step S25). Note that the connection process including subsequent processing will be described in detail later.

As described above, the terminal device 40 acquires, from the management device 10A, the use condition (the reference information about the operating environment) of the service desired to be registered for use. Therefore, the terminal device 40 is allowed to make a request for the use of the service according to the operating environment of the terminal device 40 itself. In addition, the management device 10A determines whether to permit the use of the service according to the operating environment of the terminal device 40. Therefore, the terminal device 40 is allowed to receive more stable quality service.

### 2. Configuration of Communication System

<2.1. Configuration Example of Network Architecture>

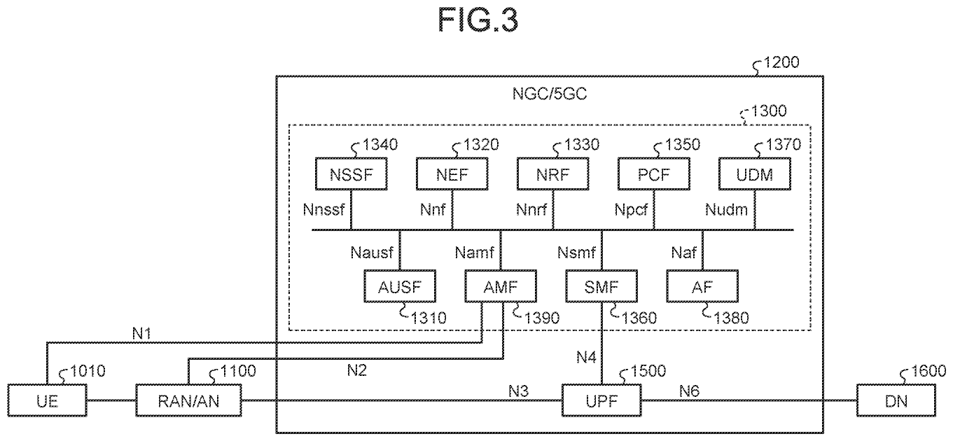

First, an architecture of a fifth generation mobile communication system (5G), that is, a 5G architecture will be described as an example of the communication system according to the present embodiment. FIG. 3 is a diagram illustrating an example of the 5G architecture. The 5G architecture includes User Equipment (UE) 1010, a Radio Access Network (RAN)/Access Network (AN) 1100, a Next Generation Core (NGC)/5G Core (5GC) 1200, and a Data Network (DN) 1600.

An example of the UE 1010 is the terminal device 40 of the present embodiment. The RAN 1100 is a base station apparatus gNB that provides a wireless interface, and the AN 1100 is, for example, an access point or a router that provides a wired interface. An example of the RAN/AN 1100 is the base station apparatus 20 according to the present embodiment.

The 5GC/NGC 1200 is also referred to as the 5G core network. The 5GC/NGC 1200 is connected to the UE 1010 via the RAN/AN 1100.

The 5GC/NGC 1200 includes a control plane function group 1300 and a User Plane Function (UPF) 1500.

The control plane function group 1300 includes an Authentication Server Function (AUSF) 1310, a Network Exposure Function (NEF) 1320, a Network Repository Function (NRF) 1330, a Network Slice Selection Function (NSSF) 1340, a Policy Control Function (PCF) 1350, a Session Management Function (SMF) 1360, a Unified Data Management (UDM) 1370, an Application Function (AF) 1380, and an Access Management Function (AMF) 1390.

The UDM 1370 has functions of generating 3GPP AKA authentication information and processing a user ID. The UDM 1370 includes a unified data repository (UDR) that holds and manages subscriber information and a Front End (FE) unit that processes the subscriber information.

In addition, the AMF 1390 has functions of registration processing, connection management, mobility management of the UE 1010, and the like. A device that implements the functions of the AMF 1390 is the management device 10A of FIGS. 1 and 2.

The SMF 1360 has functions of session management, IP assignment and management for the UE 1010, and the like. The AUSF 1310 has an authentication function. The NSSF 1340 has a function related to selection of a network slice. The NEF 1320 has a function of providing network capabilities and events to a third party, the AF 1380, and edge computing functions.

The NRF 1330 has a function of finding a network function and holding a profile of the network function. The PCF 1350 has a policy control function. The AF 1380 has a function of providing a service, interacting with the core network.

The DN 1600 is, for example, an entity that provides the service of an operator, an entity that provides Internet connection, or an entity that provides a third-party service.

(Network slice)

In the NGC/5GC 1200, in order to provide a wireless communication service according to a difference in communication characteristic for each service, the concept of network slice is introduced.

The network slice is identified by the Single Network Slice Selection Assistance Information (S-NSSAI). The S-NSSAI includes a Slice/Service type (SST) and a Slice Differentiator (SD).

The SST represents a characteristic (e.g., Enhanced Mobile Broadband (eMBB), Ultra-Reliable and Low Latency Communications (URLLC), Massive Internet of Things (MIoT), or Vehicle to something (V2X)) expected for the network slice from the viewpoint of characteristics and service. The SD is supplementary information for classifying a plurality of network slices more finely in the same SST.

The SST may have a unique standardized value or a non-standardized value. The S-NSSAI having the non-standardized value may be used locally for identification of a single network slice in the Public Land Mobile Network (PLMN), but shall not be used for processing of an access layer of the UE 1010 in any PLMN other than associated PLMN.

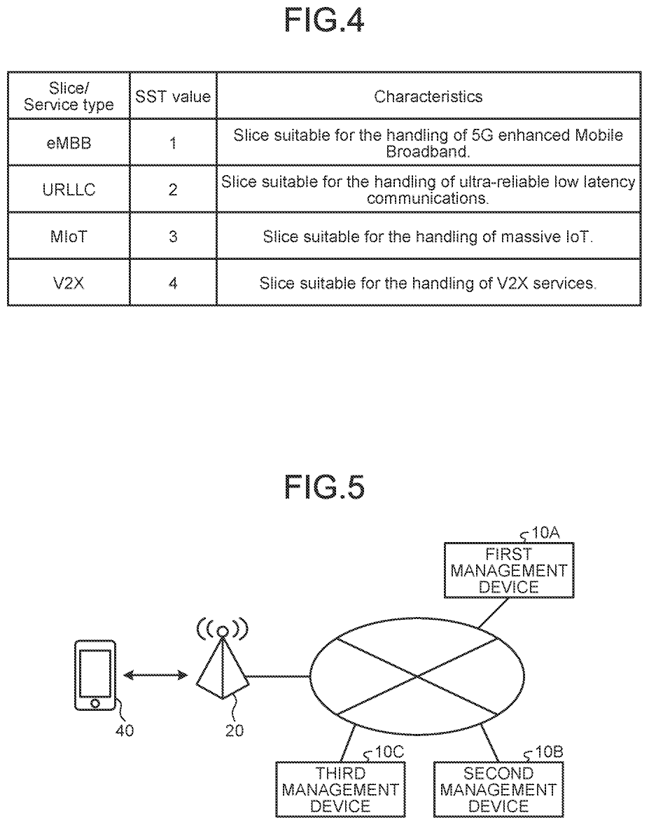

FIG. 4 is a table illustrating SST values standardized by 3GPP TS 23.501. Use of the standardized SST values makes it possible to ensure interoperability for slicing, and the PLMN can more efficiently support roaming.

(Establishment of Connection Using NSI)

Establishment of connection of User Plane with the DN 1600 via a Network Slice instance (NSI) includes the two steps of
performing a Registration Management (RM) process to select the AMF 1390 that supports a requested network slice
establishing, via the NSI, one or more PDU sessions with the DN 1600. Here, the NSI includes all network functions (NFs) used to provide a set of communication services corresponding to a certain network slice. Note that the step of performing the RM process corresponds to the registration process illustrated in FIG. 1, and part of the step of establishing the PDU session corresponds to the connection process illustrated in FIG. 2.

These processes will be described in detail later.

<2.2 Configuration Example of Communication System>

FIG. 5 is a diagram illustrating a configuration example of the communication system according to the embodiment of the present disclosure. As illustrated in FIG. 5, the communication system according to the present embodiment includes first to third management devices 10A to 10C, the base station apparatus 20, and the terminal device 40.

The first management device 10A is a device that manages the mobility of the terminal device 40 and that implements the functions of the AMF 1390. The first management device 10A corresponds to the management device 10A in FIGS. 1 and 2. The second management device 10B is a device that has a function of user plane processing and that implements the functions of the UPF 1500. The third management device 10C is a device that manages a session of the terminal device 40 and that implements the functions of the SMF 1360.

The terminal device 40 performs the registration process (RM process) on the first management device 10A via the base station apparatus 20. In addition, the terminal device 40 performs the connection process (PDU session establishment processing) on the first to third management devices 10A to 10C via the base station apparatus 20.

Note that the devices in the drawing may be considered as logical devices. In other words, some of the devices in the drawing may be implemented by a Virtual Machine (VM), Container, Docker, and the like to be implemented physically on the same hardware.

<2.2.1. Configuration Example of First Management Device 10A>

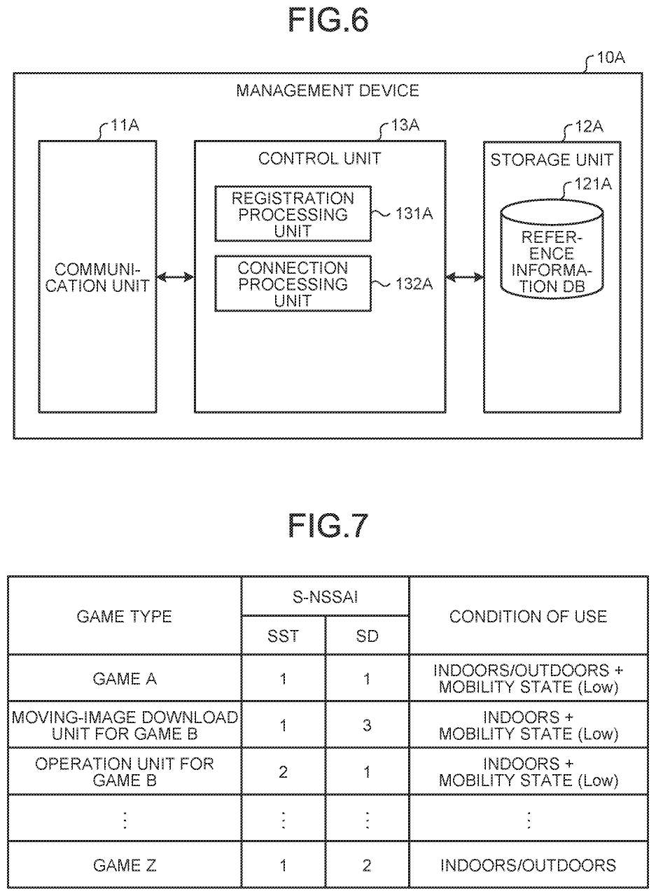

FIG. 6 is a block diagram illustrating a configuration example of the first management device 10A according to the embodiment of the present disclosure. The first management device 10A performs the registration process (RM process) and mobility management of the terminal device 40.

The first management device 10A includes a communication unit 11A, a storage unit 12A, and a control unit 13A. Note that the configuration illustrated in FIG. 6 represents a functional configuration, and the first management device 10A may have a hardware configuration different from this functional configuration. Furthermore, the functions of the first management device 10A may be distributed to and implemented in a plurality of physically separated configurations. For example, the first management device 10A may be constituted by a plurality of server devices. Furthermore, the functions of the first management device 10A may be distributed to and implemented in a plurality of dynamically and physically separated configurations.

(Communication Unit)

The communication unit 11A is a communication interface for communicating with other devices. The communication unit 11A may be a network interface or a device connection interface. The communication unit 11A has a function of direct or indirect connection to a network. For example, the communication unit 11A may include a Local Area Network (LAN) interface such as a Network Interface Card (NIC) or may include a Universal Serial Bus (USB) interface including a USB host controller, a USB port, and the like. Furthermore, the communication unit 11A may be a wired interface or a wireless interface. Here, the communication interface supports, for example, N2 and Namf interfaces. The communication unit 11A functions as communication means of the first management device 10A. The communication unit 11A communicates with the base station apparatus 20 and the third management device 10C, according to the control of the control unit 13A.

(Storage Unit)

The storage unit 12A is a data readable/writable storage device such as a Dynamic Random Access Memory (DRAM), Static Random Access Memory (SRAM), flash memory, or hard disk. The storage unit 12A functions as storage means of the first management device 10A. The storage unit 12A includes a reference information DB 121A.

The reference information DB 121A stores the reference information about the operating environment requested for the terminal device 40, as a condition for using a service. Here, the operating environment according to the present embodiment will be described.

[Operating Environment]

In 5G, it is expected to achieve a use case in which a control signal from a Head Mount Display (HMD) or a game console is wirelessly transmitted to a game device to wirelessly transmit a large volume of VR moving image from the game device to the HMD. Therefore, it is considered to use a millimeter wave that is relatively easily use a wide frequency band so as to wirelessly transmit low latency, high-volume data.

The millimeter wave has a large propagation loss and high rectilinear propagation as compared with the 2 GHz band currently used in cellular communication. Therefore, it is not always easy to ensure sufficient communication stability in the 4G communication technology. In 5G, use of a technology called beamforming has been considered in order to compensate for a large propagation loss that is a problem of such millimeter waves. The millimeter waves have a short wavelength, and thus, it is easy to construct an antenna array by using more antenna elements, and it is possible to ensure an S/N ratio by forming a sharp beam and compensating for the propagation loss.

However, it is not always easy to track a wireless communication device (the terminal device 40) having high mobility with a beam, and even if it is possible, there is a concern that power consumption increases. Furthermore, a problem has been pointed out that the millimeter waves are blocked by an obstacle or the like and communication tends to be unstable. In particular, it is considered that use of the millimeter waves in an environment, such as outdoors, where more dynamic influences are exerted by many obstacles is not facilitated. Therefore, it is expected that the use of the millimeter waves at the beginning of the introduction of 5G will be restricted in an environment where the obstacles have more static influences, such as indoors.

In addition, gaming on smartphones has become widespread in 4G. However, in 5G, it is considered that a cloud game where gaming requiring a larger calculation capability is processed on a cloud server will become possible to be used on the smartphones. Depending on the type of the game, wireless communication between the cloud server that processes the game and a smartphone that operates the game and displays a moving image requires a low latency. Therefore, it may be necessary to use a technology called Mobile Edge Computing (MEC). In the MEC, a cloud server having the smallest latency is selected from among available cloud servers for gaming processing, according to the mobility of the smartphone (an example of the terminal device 40). Here, the cloud server corresponds to the DN 1600 (see FIG. 3) of the 5G architecture, and the smartphone that operates the game and displays the moving image corresponds to the UE 1010. Note that the cloud game is an example of an application (service), and the application is not limited to the gaming. For example, the application may be a streaming application for music content such as a song, or a movie or moving image content captured in a live broadcast.

It is considered that the cloud game is played not only indoors but also outdoors. In addition, the cloud game includes a game that requires download of a large amount of moving image data with a low latency, and a game that is relatively tolerant to latency and has a small size of data to be downloaded. Therefore, it is considered that the cloud game can be classified into a plurality of slices from the viewpoint of the network slicing. Furthermore, each of a plurality of processes may be classified into a plurality of slices, depending on the processing content in one game. For example, interactive processing (operation of the user and operation of the server (cloud or edge) responding to the operation) may be required to have low latency to avoid a reduction in QoE. Meanwhile, rendering processing may be required not to have a low latency but to perform a large-capacity data processing, as compared with the interactive processing.

From the above, for a condition of using the wireless communication service supporting a VR game and the cloud game, for example, for the operating environment of the terminal device 40, use of HMD or a game console that serves as the terminal device 40 indoors is set. Furthermore, for a condition of using the wireless communication service supporting the VR game, for example, for the operating environment of the terminal device 40, a Mobility State may be set.

Here, the mobility state may include not only a state related to a moving speed of the terminal device 40 but also a motion state of the terminal device 40 (user). Examples of the motion state include an action of the user, such as standing, sitting, walking, running, riding on a bicycle, getting on a train, getting on a bus, getting in a car, and moving in an elevator. The motion state can be recognized by the terminal device 40 by using an activity recognition function, for example, Artificial Intelligence (AI) mounted on the terminal device 40 itself. Recognition of the motion state by the terminal device 40 will be described later.

Furthermore, the number of beams simultaneously receivable, the number of antenna panels, or the number of antenna layers, or the number of Transmission and Reception Points (TRPs) that enables simultaneous reception, UE capability, or UE category may be set, as the condition for using the wireless communication service supporting the VR game, for example, as the operating environment of the terminal device 40. Furthermore, for the condition for using the wireless communication service supporting the VR game, for example, for the operating environment of the terminal device 40, the presence or absence of a specific sensor that the terminal device 40 needs to be provided with may be set. Furthermore, for the operating environment of the terminal device 40, the version of an Operation System (OS) or firmware that is supported by the terminal device 40 may be set.

FIG. 7 is a table illustrating an example of the reference information DB 121A according to the embodiment of the present disclosure. FIG. 7 illustrates an example of the services, that is, a correspondence between the games provided via the wireless network and the reference information about the use conditions, for example, the operating environments of the terminal device 40. Here, even in one game, the S-NSSAI is assigned for each function (e.g., a moving-image download unit for a game B, an operation unit for the game B, etc.), in some cases.

As illustrated in FIG. 7, in a game A, SST is 1 and SD is 1. In other words, the game A is classified in eMBB_1 where the service is available indoors, or outdoors in a low mobility condition as the operating environment of the UE.

As described above, the game B is classified according to the moving-image download unit and the operation unit. In the moving-image download unit for the game B, SST is 1 and SD is 3. In other words, the moving-image download unit for the game B is classified in eMBB_3 where the service is available indoors in a low mobility condition as the operating environment of the UE. In addition, in the operation unit for the game B, SST is 2 and SD is 1. In other words, the operation unit for the game B is classified in URLLC_1 where the service is available indoors in a low mobility condition as the operating environment of the UE.

In a game Z, SST is 1 and SD is 2. In other words, the game Z is classified in eMBB_2 where the service is available indoors or outdoors as the operating environment of the UE.

Here, the eMBB is further classified by the SD, but the classification by the SD is performed, for example, according to a difference in required latency. For example, eMBB_3 (SD=3) is classified as a communication service that has a lower latency than eMBB_1 (SD=1), and eMBB_2 (SD=2) is classified as a communication service that is more tolerant to latency than eMBB_1 (SD=1). Furthermore, the classification by the SD may be performed, for example, according to a difference in data rate required. For example, eMBB_2 (SD=2) is classified as a communication service that can be supported even at a data rate lower than that in eMBB_1 (SD=1).

For example, the game B needs to simultaneously use two network slices, that is, eMBB_3 (SST=1, SD=3) and URLLC_1 (SST=2, SD=1). Therefore, to the operating environment of the terminal device 40 for playing the game B, mounting two or more transmitters/receivers in the terminal device 40 may be added.

For example, the network may be notified of information about the configurations of such transmitters/receivers, as UE Radio Capability information. Note that the terminal device 40 notifies the first management device 10A (AMF) of the UE Radio Capability information in the registration process, and the first management device 10A holds the UE Radio Capability information while the terminal device 40 is registered on the first management device 10A (AMF). The registration process will be described in detail later.

The first management device 10A transmits the latest UE Radio Capability information to the base station apparatus 20 by using an N2 PDU Session Request message.

When a registration state of the terminal device 40 in the first management device 10A transitions to RM-DEREGISTERED, the first management device 10A deletes the held UE Radio Capability information. In addition, in a case where the UE Radio Capability information is changed in CM-IDLE, the terminal device 40 performs Mobility Registration Update for UE Radio Capability Update.

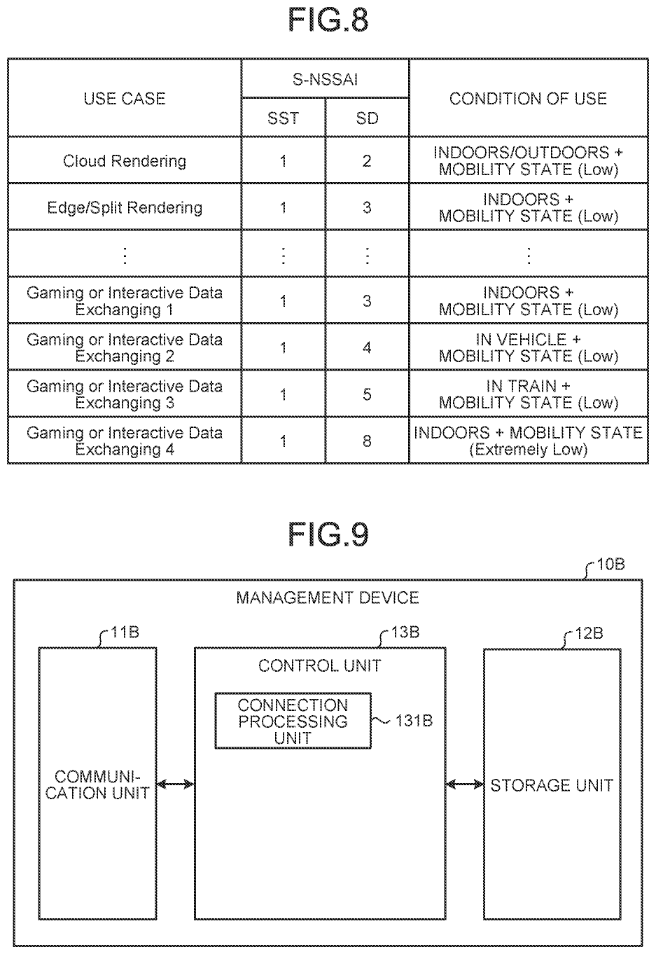

In FIG. 7, the correspondence between each game function via the wireless network and the reference information is illustrated, but the correspondence is not limited thereto. For example, the reference information may be made to correspond to each use case via the wireless network. This configuration will be described with reference to FIG. 8.

FIG. 8 is a table illustrating another example of the reference information DB 121A according to the embodiment of the present disclosure. Here, a correspondence between classifications of the use cases of Augmented Reality (AR)/Virtual Reality (VR) that requires a broadband and low latency, and the use conditions is illustrated. In particular, the required strict latency is widely known as Motion to Photon latency.

For example, Cloud Rendering that is a rendering process performed by a cloud server is classified as a use case more tolerant to the latency than Edge Rendering that is rendering process performed by an edge server. This is because it is assumed that processing is caused to be performed by the cloud server that is not necessarily the edge server in order to provide the service to the terminal device 40 having some mobility.

For example, when a delay budget that can be allocated to the wireless unit is reduced, such as when the server is caused to perform considerably large processing, Edge/Split Rendering attempts to reduce the latency between the terminal device 40 and the server by using a technology called Mobile Edge Computing (MEC). Limiting the operating environment of the Edge/Split Rendering to indoors with respect to an operating environment of the Cloud Rendering, it is possible to avoid complex mobility processing of the MEC, and stable performance can be expected.

Furthermore, the use case of Gaming or Interactive Data Exchanging is classified into, for example, four as illustrated in FIG. 8, according to the limitation of the operating environment.

Gaming or Interactive Data Exchanging 1 is, for example, a use case assumed to be used at home or in a commercial facility.

Gaming or Interactive Data Exchanging 2 is a use case assumed to be used in a vehicle, such as a taxi or a bus, in which a local base station (an example of the base station apparatus 20) is installed. In other words, mobility equivalent to that of the Gaming or Interactive Data Exchanging 1 is assumed in the vehicle, and the mobility of the moving speed of the vehicle with respect to the backhaul of the local base station is considered.

Gaming or Interactive Data Exchanging 3 is a use case assumed to be used in a train that is, for example, faster than the taxi and the bus and that has a local base station (an example of the base station apparatus 20). In other words, mobility equivalent to Gaming or Interactive Data Exchanging 1 is assumed in the train, and the mobility with respect to the moving speed of the train is considered with respect to the backhaul of the local base station.

Likewise the Gaming or Interactive Data Exchanging 1, Gaming or Interactive Data Exchanging 4 is a use case that is assumed to be used at home or in a commercial facility, but more strict latency and reliability are required for radio communication. In other words, smaller mobility is required for the terminal device 40.

Note that the classification in FIGS. 7 and 8 is merely an example and it is needless to say that classification other than that in FIGS. 7 and 8 may be used as long as the classification is based on the concept of classification according to a difference in operating environment, in view of wireless characteristics.

(Control Unit)

Returning to FIG. 6, the configuration example of the first management device 10A will be continued again. The control unit 13A is a controller that controls the respective units of the first management device 10A. The control unit 13A is implemented by a processor such as a Central Processing Unit (CPU) or a Micro Processing Unit (MPU). For example, the control unit 13A is implemented by running various programs stored in the storage device in the first management device 10A by the processor, with a Random Access Memory (RAM) as a working area. In addition, the control unit 13A may be implemented by an integrated circuit such as an Application Specific Integrated Circuit (ASIC) or a Field Programmable Gate Array (FPGA). The CPU, MPU, ASIC, and FPGA can all be regarded as the controllers.

The control unit 13A includes a registration processing unit 131A and a connection processing unit 132A. The registration processing unit 131A performs the registration process for the terminal device 40. The connection processing unit 132A performs the PDU session establishment processing (connection process) in response to the request from the terminal device 40. The registration process and the connection process will be described in detail later.

<2.2.2. Configuration Example of Second Management Device 10B>

FIG. 9 is a block diagram illustrating a configuration example of the second management device 10B according to the embodiment of the present disclosure. The second management device 10B has the function of user plane processing.

The second management device 10B includes a communication unit 11B, a storage unit 12B, and a control unit 13B. Note that the configuration illustrated in FIG. 9 represents a functional configuration, and the second management device 10B may have a hardware configuration different from this functional configuration. Furthermore, the functions of the second management device 10B may be distributed to and implemented in a plurality of physically separated configurations. For example, the second management device 10B may be constituted by a plurality of server devices. Furthermore, the functions of the second management device 10B may be distributed to and implemented in a plurality of dynamically and physically separated configurations.

(Communication Unit)

The communication unit 11B is a communication interface for communicating with other devices. Here, the communication interface supports, for example, N3 and N4 interfaces. Note that the communication unit 11B may have a configuration similar to that of the communication unit 11A of the first management device 10A. The communication unit 11B functions as communication means for the second management device 10B. The communication unit 11B communicates with the base station apparatus 20 and the third management device 10C, according to the control of the control unit 13B.

(Storage Unit)

The storage unit 12B is a data readable/writable storage device such as a Dynamic Random Access Memory (DRAM), Static Random Access Memory (SRAM), flash memory, or hard disk. The storage unit 12B functions as storage means of the second management device 10B.

(Control Unit)

The control unit 13B is a controller that controls each unit of the second management device 10B. The control unit 13B is implemented by a processor such as a Central Processing Unit (CPU) or a Micro Processing Unit (MPU). For example, the control unit 13B is implemented by running various programs stored in the storage device in the second management device 10B by the processor, with a Random Access Memory (RAM) as a working area. In addition, the control unit 13B may be implemented by an integrated circuit such as an Application Specific Integrated Circuit (ASIC) or a Field Programmable Gate Array (FPGA). The CPU, MPU, ASIC, and FPGA can all be regarded as the controllers.

The control unit 13B includes a connection processing unit 131B. The connection processing unit 131B performs the PDU session establishment processing (connection process) in response to the request from the terminal device 40. The connection process will be described in detail later.

<2.2.3. Configuration Example of Third Management Device 10C>

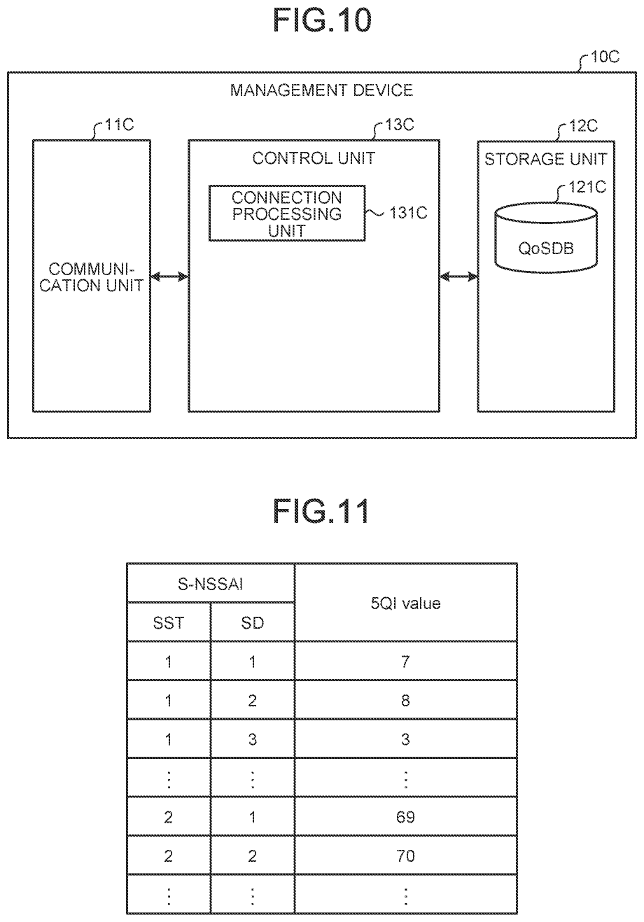

FIG. 10 is a block diagram illustrating a configuration example of the third management device 10C according to an embodiment of the present disclosure. The third management device 10C manages the session of the terminal device 40.

The third management device 10C includes a communication unit 11C, a storage unit 12C, and a control unit 13C. Note that the configuration illustrated in FIG. 10 represents a functional configuration, and the third management device 10C may have a hardware configuration different from this functional configuration. Furthermore, the functions of the third management device 10C may be distributed to and implemented in a plurality of physically separated configurations. For example, the third management device 10C may be constituted by a plurality of server devices. Furthermore, the functions of the third management device 10C may be distributed to and implemented in a plurality of dynamically and physically separated configurations.

(Communication Unit)

The communication unit 11C is a communication interface for communicating with other devices. Here, the communication interface supports, for example, Nsmf and N4 interfaces. Note that the communication unit 11C may have a configuration similar to that of the communication unit 11A of the first management device 10A. The communication unit 11C functions as communication means for the third management device 10C. The communication unit 11C communicates with the first and second management devices 10A and 10B according to the control of the control unit 13C.

(Storage Unit)

The storage unit 12C is a data readable/writable storage device such as a Dynamic Random Access Memory (DRAM), Static Random Access Memory (SRAM), flash memory, or hard disk. The storage unit 12C functions as storage means of the third management device 10C. The storage unit 12C includes QoSDB 121C.

The QoSDB 121C stores a 5QI value corresponding to each S-NSSAI. The 5QI (5G QoS Identifier) is an identifier for identifying QoS in 5G.

Here, Quality of Service (QoS) control in a 5G system (5GS) will be described. The QoS control in 5GS is performed on the basis of a QoS flow (QoS Flows). The QoS control in 5G supports both of GBR QoS Flows that guarantees a flow bit rate and Non-GBR QoS Flows that do not guarantee the flow bit rate.

The QoS Flow is a minimum unit that differentiates QoS in a PDU session, and a QoS Flow ID (QFI) is used to identify the QoS flow. Multiple QoS Flows are allowed within one PDU session. The QFI may be dynamically assigned or identical to the 5QI. The QoS Flow is controlled by the third management device 10C (SMF).

The QoSDB 121C stores the 5QI value corresponding to each S-NSSAI. The third management device 10C (SMF) instructs the second management device 10B (UPF) to process data transferred on each service, as the QoS Flow to which the 5QI corresponding to each service is assigned, on the basis of the S-NSSAI corresponding to the service and the table illustrated in FIG. 11. Note that FIG. 11 is a table illustrating an example of the QoSDB 121C according to the embodiment of the present disclosure.

For example, as illustrated in FIG. 11, the 5QI value of “7” is assigned to the network slice of eMBB_1 (SST=1, SD=1), and the 5QI value of “69” is allocated to the network slice of URLLC_1 (SST=2, SD=1).

(Control Unit)

The control unit 13C is a controller that controls each unit of the third management device 10C. The control unit 13C is implemented by a processor such as a Central Processing Unit (CPU) or a Micro Processing Unit (MPU). For example, the control unit 13C is implemented by running various programs stored in the storage device in the third management device 10C by the processor, with a Random Access Memory (RAM) as a working area. In addition, the control unit 13C may be implemented by an integrated circuit such as an Application Specific Integrated Circuit (ASIC) or a Field Programmable Gate Array (FPGA). The CPU, MPU, ASIC, and FPGA can all be regarded as the controllers.

The control unit 13C includes a connection processing unit 131C. The connection processing unit 131C performs the PDU session establishment processing (connection process) in response to the request from the terminal device 40. The connection process will be described in detail later.

<2.2.4. Configuration Example of Base Station Apparatus>

The base station apparatus 20 is a wireless communication device that wirelessly communicates with the terminal device 40. The base station apparatus 20 is a type of communication device. The base station apparatus 20 is, for example, a device corresponding to a radio base station (Node B, eNB, gNB, ng-eNB, etc.) or a wireless Access Point. The base station apparatus 20 may be a radio relay station or a donor node of Integrated Access and Backhaul (IAB). The base station apparatus 20 may be a base station apparatus on a road such as a Road Side Unit (RSU). Here, a base station apparatus on a road can include a configuration of a traffic light that has a function of the base station apparatus or a relay station apparatus. Alternatively, the base station apparatus on a road may have a configuration of the terminal device 40 having a relay function incorporated in a traffic light. In other words, the RSU may be the terminal device 40 having the function of Network to UE relay. Furthermore, the base station apparatus 20 may be an optical remote device called Remote Radio Head (RRH). In the present embodiment, the base station of a radio communication system is referred to as the base station apparatus, in some cases. The base station apparatus 20 may be capable of wirelessly communicating with another base station apparatus 20.

Note that the concept of the base station apparatus (also referred to as base station) includes not only a donor base station but also a relay base station (also referred to as relay station or relay station apparatus). Furthermore, the concept of the base station includes not only a structure with a function of the base station but also a device installed at the structure. Examples of the structure include buildings such as a high-rise building, house, steel tower, station facility, airport facility, harbor facility, and a stadium. Note that the concept of the structure includes not only the building but also non-building structures such as a tunnel, bridge, dam, fence, and steel column, and facilities such as a crane, gate, and windmill. In addition, the concept of the structure includes not only structures on land (on the ground) or under the ground but also structures on the water such as a pier and megafloat, and structures under the water such as an ocean observation facility. The base station apparatus can be also referred to as a processing device (or information processing device).

The base station apparatus 20 may be a fixed station or a movable base station apparatus (mobile station). For example, the base station apparatus 20 may be a device installed at a mobile object or the mobile object itself. For example, the relay station apparatus having mobility can be regarded as the base station apparatus 20 as the mobile station. In addition, a device such as a vehicle, drone, or smartphone that originally has mobility and that has a function of the base station apparatus (at least part of the function of the base station apparatus) also corresponds to the base station apparatus 20 as the mobile station.

Here, the mobile object may be a mobile terminal such as a smartphone or a mobile phone. Furthermore, the mobile object may be a mobile object (e.g., a vehicle such as an automobile, bicycle, bus, truck, motorcycle, train, or linear motor car) that moves on land (on the ground) or a mobile object (e.g., subway) that moves under the ground (e.g., in a tunnel). Furthermore, the mobile object may be a mobile object (e.g., a ship such as a passenger ship, cargo ship, or hovercraft) that moves on the water or a mobile object (e.g., a submersible ship such as a submersible vessel, submarine boat, or unmanned submersible) that moves under water. Still furthermore, the mobile object may be a mobile object (e.g., an aircraft such as an airplane, airship, or drone) that moves in the atmosphere or a mobile object (e.g., an artificial celestial body such as an artificial satellite, spacecraft, space station, or probe vehicle) that moves above the atmosphere.

Furthermore, the base station apparatus 20 may be a ground base station apparatus (ground station apparatus) installed on the ground. For example, the base station apparatus 20 may be a base station apparatus arranged in a structure on the ground or a base station apparatus installed in a mobile object moving on the ground. More specifically, the base station apparatus 20 may be an antenna installed on a structure such as a building and a signal processing device connected to the antenna. As a matter of course, the base station apparatus 20 may be the structure or the mobile object itself. “On the ground” represents not only on land (on the ground) but also under the ground, on the water, and under the water in a broad sense. Note that the base station apparatus 20 is not limited to the ground base station apparatus. The base station apparatus 20 may be a non-ground base station apparatus (non-ground station apparatus) that is configured to float in the air or in space. For example, the base station apparatus 20 may be an aircraft station apparatus or a satellite station apparatus.

The aircraft station apparatus is a wireless communication device that is configured to float in the atmosphere, such as an aircraft. The aircraft station apparatus may be a device mounted on an aircraft or the like or may be the aircraft itself. Note that the concept of aircraft includes not only a heavier-than-air aircraft such as an airplane or glider, but also a lighter-than-air aircraft such as a balloon or airship. Furthermore, the concept of aircraft includes not only the heavier-than-air aircraft or lighter-than-air aircraft, but also a rotorcraft such as a helicopter or autogiro. Note that the aircraft station apparatus (or an aircraft on which the aircraft station apparatus is mounted) may be an Unmanned Aerial Vehicle (UAV) such as a drone. Note that the concept of Unmanned Aerial Vehicle also includes Unmanned Aircraft Systems (UAS) and tethered UAS. Furthermore, the concept of Unmanned Aerial Vehicle includes a Lighter than Air UAS (LTA) and a Heavier than Air UAS (HTA). In addition, the concept of Unmanned Aerial Vehicle also includes High Altitude UAS Platforms (HAPs).

The satellite station apparatus is a wireless communication device that is configured to float above the atmosphere. The satellite station apparatus may be a device mounted on a space vehicle such as an artificial satellite or may be the space vehicle itself. A satellite serving as the satellite station apparatus may be any of a Low Earth Orbiting (LEO) satellite, Medium Earth Orbiting (MEO) satellite, Geostationary Earth Orbiting (GEO) satellite, and Highly Elliptical Orbiting (HEO) satellite. As a matter of course, the satellite station apparatus may be a device mounted on the low earth orbiting satellite, medium earth orbiting satellite, geostationary earth orbiting satellite, or highly elliptical orbiting satellite.

Furthermore, the satellite station apparatus may have a function of the relay station for the ground base station using a bent-pipe system.

The base station apparatus 20 may provide large coverage, such as a macrocell, or small coverage, such as a picocell. As a matter of course, the base station apparatus 20 may provide extremely small coverage, such as a femtocell. Furthermore, the base station apparatus 20 may have beamforming capability. In this case, a cell or service area may be formed for each beam from the base station apparatus 20.

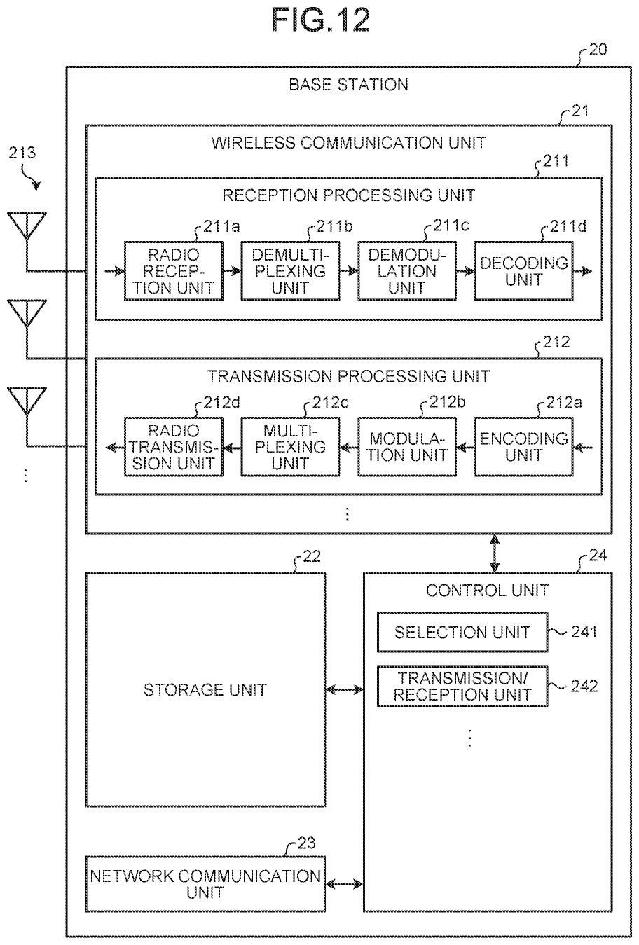

FIG. 12 is a block diagram illustrating a configuration example of the base station apparatus 20 according to the embodiment of the present disclosure. The base station apparatus 20 includes a wireless communication unit 21, a storage unit 22, a network communication unit 23, and a control unit 24. Note that the configuration illustrated in FIG. 12 represents a functional configuration, and the base station apparatus 20 may have a hardware configuration different from this functional configuration. Furthermore, the functions of the base station apparatus 20 may be distributed to and implemented in a plurality of physically separated configurations.

The wireless communication unit 21 is a wireless communication interface that wirelessly communicates with other wireless communication devices (e.g., the base station apparatus 20 and each terminal device 40). The wireless communication unit 21 operates according to the control of the control unit 24. Note that the wireless communication unit 21 may support a plurality of radio access systems. For example, the wireless communication unit 21 supports both of NR and LTE. The wireless communication unit 21 may support W-CDMA and cdma2000 in addition to NR and LTE. The wireless communication unit 21 may support a radio access system other than NR, LTE, W-CDMA, and cdma2000.

The wireless communication unit 21 includes a reception processing unit 211, a transmission processing unit 212, and an antenna 213. The wireless communication unit 21 may include a plurality of reception processing units 211, transmission processing units 212, and antennas 213. Note that when the wireless communication unit 21 supports a plurality of radio access systems, each unit of the wireless communication unit 21 can be configured for each of the radio access systems. For example, the reception processing unit 211 and the transmission processing unit 212 may be configured individually for LTE and NR.

The reception processing unit 211 processes an uplink signal received via the antenna 213. The reception processing unit 211 includes a radio reception unit 211a, a demultiplexing unit 211b, a demodulation unit 211c, and a decoding unit 211d.

The radio reception unit 211a performs, on the uplink signal, down conversion, removal of an unnecessary frequency component, control of an amplification level, quadrature demodulation, conversion to a digital signal, removal of a guard interval, and extraction of a frequency domain signal by fast Fourier transform, or the like. The demultiplexing unit 211b demultiplexes an uplink channel and an uplink reference signal, such as Physical Uplink Shared Channel (PUSCH) and Physical Uplink Control Channel (PUCCH), from a signal output from the radio reception unit 211a. The demodulation unit 211c uses a modulation method such as Binary Phase Shift Keying (BPSK) or Quadrature Phase shift Keying (QPSK) for a modulation symbol in the uplink channel to demodulate a received signal. The modulation method used by the demodulation unit 211c may include 16 quadrature amplitude modulation (QAM), 64QAM, 256QAM, or 1024QAM. The decoding unit 211d performs decoding processing on encoded bits in the uplink channel demodulated. Decoded uplink data and uplink control information are output to the control unit 24.

The transmission processing unit 212 performs transmission processing for downlink control information and downlink data. The transmission processing unit 212 includes an encoding unit 212a, a modulation unit 212b, a multiplexing unit 212c, and a radio transmission unit 212d.

The encoding unit 212a encodes the downlink control information and downlink data that are input from the control unit 24, by using an encoding method such as block encoding, convolutional encoding, turbo encoding, Low-Density Parity-Check (LDPC) encoding, or polar encoding. The modulation unit 212b modulates encoded bits output from the encoding unit 212a by using a predetermined modulation method such as BPSK, QPSK, 16QAM, 64QAM, 256QAM, or 1024QAM. The multiplexing unit 212c multiplexes a modulation symbol and a downlink reference signal from each channel so as to be arranged in a predetermined resource element. The radio transmission unit 212d performs various types of signal processing on a signal from the multiplexing unit 212c. For example, the radio transmission unit 212d performs processing such as conversion to the time domain by using fast Fourier transform, addition of the guard interval, generation of a baseband digital signal, conversion to an analog signal, quadrature modulation, up-conversion, removal of an unnecessary frequency component, and amplification of power. A signal generated by the transmission processing unit 212 is transmitted from the antenna 213.

The storage unit 22 is a data readable/writable storage device such as DRAM, SRAM, a flash memory, or a hard disk. The storage unit 22 functions as storage means of the base station apparatus 20.

The network communication unit 23 is a communication interface for communication with other devices (e.g., the first management device 10A, the second management device 10B, and another base station apparatus 20). Here, the communication interface supports, for example, N2, N3, X2, and Xn interfaces. For example, the network communication unit 23 includes a LAN interface such as NIC. The network communication unit 23 may be a wired interface or a wireless interface. The network communication unit 23 functions as network communication means of the base station apparatus 20. The network communication unit 23 communicates with the other devices according to the control of the control unit 24. The network communication unit 23 may have a configuration similar to those of the first to third management devices 10A to 10C.

The control unit 24 is a controller that controls each unit of the base station apparatus 20. The control unit 24 is implemented by a processor such as a Central Processing Unit (CPU) or a Micro Processing Unit (MPU). For example, the control unit 24 is implemented by running various programs stored in the storage device in the base station apparatus 20 by the processor, with a Random Access Memory (RAM) as a working area. In addition, the control unit 24 may be implemented by an integrated circuit such as an Application Specific Integrated Circuit (ASIC) or a Field Programmable Gate Array (FPGA). The CPU, MPU, ASIC, and FPGA can all be regarded as the controllers.

The control unit 24 includes a selection unit 241 and a transmission/reception unit 242. When receiving the registration request from the terminal device 40, the selection unit 241 selects the first management device 10A to which the registration request is transferred. The transmission/reception unit 242 receives a signal from the terminal device 40, and transfers the signal from the terminal device 40 to the first management device 10A as necessary.

<2.2.5. Configuration Example of Terminal Device>

The terminal device 40 is a wireless communication device that wirelessly communicates with the base station apparatus 20. The terminal device 40 is, for example, a mobile phone, a smart device (smartphone or tablet), a Personal Digital Assistant (PDA), or a personal computer. Furthermore, the terminal device 40 may be a Machine to Machine (M2M) device or an Internet of Things (IoT) device. For example, the terminal device 40 may be a head mounted display (HMD), or a headset for use of Virtual Reality (VR)/Augmented Reality (AR)/Mixed Reality (MR)/Substitutional Reality (SR)/X Reality (XR).

Note that the terminal device 40 may be a wireless communication device installed at a mobile object or the mobile object itself. For example, the terminal device 40 may be a vehicle, such as an automobile, bus, truck, or motorcycle that moves on a road or a vehicle such as train that moves on a track called a rail, or a wireless communication device mounted on such a vehicle. Furthermore, the terminal device 40 may be configured to perform communication (sidelink) with another terminal device 40.

Note that the “mobile device” is a type of communication device and is also referred to as mobile station, mobile station apparatus, terminal device, or terminal. The concept of “mobile device” includes not only a communication device configured to be movable but also a mobile object at which a communication device is installed. At this time, the mobile object may be a mobile terminal, or may be a mobile object that moves on land (on the ground), under the ground, on the water, or under the water. Furthermore, the mobile object may be a mobile object such as Unmanned Aerial Vehicle (UAV) including a drone or a helicopter that moves in the atmosphere or may be a mobile object such as an artificial satellite that moves above the atmosphere.

In the present embodiment, the concept of communication device includes not only a portable mobile device (terminal device) such as a mobile terminal but also a device installed at a structure or mobile object. The structure or the mobile object itself may be regarded as the communication device. Furthermore, the concept of communication device includes not only the mobile device (terminal device, automobile, etc.) but also the base station apparatus (donor base station, relay base station, etc.). The communication device is a type of processing device and information processing device.

The terminal device 40 and the base station apparatus 20 are connected to each other by wireless communication (e.g., radio waves or optical radio). When the terminal device 40 moves from a communication area (or cell) of a certain base station apparatus to a communication area (or cell) of another base station apparatus, cell selection/cell reselection or handover (or handoff) is performed.

The terminal device 40 may be simultaneously connected to a plurality of base station apparatuses or a plurality of cells to perform communication. For example, in a case where one base station apparatus 20 supports a communication area via a plurality of cells (e.g., pCell and sCell), it is possible to combine the plurality of cells by a Carrier Aggregation (CA) technology, a Dual Connectivity (DC) technology, or a Multi-Connectivity (MC) technology to perform communication between the base station apparatus 20 and the terminal device 40. Alternatively, it is also possible for the terminal device 40 and a plurality of base station apparatuses 20 to perform communication with each other via the cells of the different base station apparatuses by using a Coordinated Multi-Point Transmission and Reception (CoMP) technology. Furthermore, in the Coordinated Multi-Point Transmission and Reception, spatial multiplexing, that is, communication with a plurality of base station apparatuses using the same radio resource is also allowed.

Note that the terminal device 40 is not necessarily a device directly used by a person. The terminal device 40 may be a sensor installed in a machine, industrial machine, robot, or the like in a factory, as in so-called machine type communication (MTC). Furthermore, the terminal device 40 may be a Machine to Machine (M2M) device or an Internet of Things (IoT) device. Furthermore, the terminal device 40 may be a device having a relay communication function as represented by Device to Device (D2D) or Vehicle to everything (V2X). Furthermore, the terminal device 40 may be a device called Client Premises Equipment (CPE) used for radio backhaul or the like. Furthermore, the terminal device 40 may be a robot whose operation is wirelessly controlled, or may be an actuator that achieves a partial operation of the robot wirelessly.

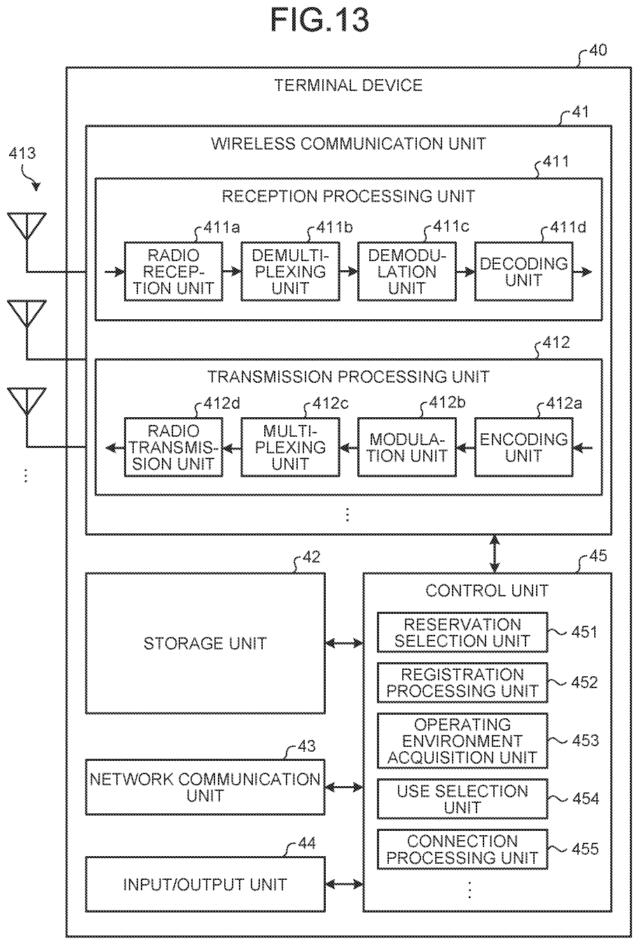

FIG. 13 is a diagram illustrating a configuration example of the terminal device 40 according to the embodiment of the present disclosure. The terminal device 40 includes a wireless communication unit 41, a storage unit 42, a network communication unit 43, an input/output unit 44, and a control unit 45. Note that the configuration illustrated in FIG. 13 represents a functional configuration, and the terminal device 40 may have a hardware configuration different from this functional configuration. Furthermore, the functions of the terminal device 40 may be distributed to and implemented in a plurality of physically separated configurations.

The wireless communication unit 41 is a wireless communication interface that wirelessly communicates with another wireless communication device (e.g., the base station apparatus 20). Here, the wireless communication interface supports, for example, a Uu interface. The wireless communication unit 41 operates according to the control of the control unit 45. The wireless communication unit 41 supports one or a plurality of radio access systems. For example, the wireless communication unit 41 supports both of NR and LTE. The wireless communication unit 41 may support W-CDMA or cdma2000 in addition to the NR and LTE.

The wireless communication unit 41 includes a reception processing unit 411, a transmission processing unit 412, and an antenna 413. The wireless communication unit 41 may include a plurality of reception processing units 411, transmission processing units 412, and antennas 413. Note that in a case where the wireless communication unit 41 supports the plurality of radio access systems, each unit of the wireless communication unit 41 can be configured for each of the radio access systems. For example, the reception processing unit 411 and the transmission processing unit 412 may be configured individually for LTE and NR.

The reception processing unit 411 performs processing on a downlink signal received via the antenna 413. Here, the reception processing unit 411 may perform beamforming reception using a plurality of antennas 413. The reception processing unit 411 includes a radio reception unit 411a, a demultiplexing unit 411b, a demodulation unit 411c, and a decoding unit 411d.

The radio reception unit 411a performs, on the downlink signal, down conversion, removal of an unnecessary frequency component, control of an amplification level, quadrature demodulation, conversion to a digital signal, removal of the guard interval, and extraction of a frequency domain signal by fast Fourier transform, or the like. The demultiplexing unit 411b demultiplexes a downlink channel, a downlink synchronization signal, and the downlink reference signal, from a signal output from the radio reception unit 411a. The downlink channel is a channel such as a Physical Broadcast Channel (PBCH), Physical Downlink Shared Channel (PDSCH), or Physical Downlink Control Channel (PDCCH). The demodulation unit 211c uses a modulation method such as BPSK, QPSK, 16QAM, 64QAM, 256QAM, or 1024QAM, for a modulation symbol in the downlink channel to demodulate the received signal. The decoding unit 411d performs decoding processing on encoded bits in the downlink channel demodulated. The downlink data and downlink control information that are decoded are output to the control unit 45.

The transmission processing unit 412 performs transmission processing for the uplink control information and the uplink data. The transmission processing unit 412 includes an encoding unit 412a, a modulation unit 412b, a multiplexing unit 412c, and a radio transmission unit 412d.

The encoding unit 412a encodes the uplink control information and uplink data that are input from the control unit 45, by using an encoding method such as block encoding, convolutional encoding, turbo encoding, Low-Density Parity-Check (LDPC) encoding, or polar encoding. The modulation unit 412b modulates encoded bits output from the encoding unit 412a by using a predetermined modulation method such as BPSK, QPSK, 16QAM, 64QAM, 256QAM, or 1024QAM. The multiplexing unit 412c multiplexes a modulation symbol and an uplink reference signal from each channel so as to be arranged in a predetermined resource element. The radio transmission unit 412d performs various types of signal processing on a signal from the multiplexing unit 412c. For example, the radio transmission unit 412d performs processing such as conversion to the time domain by using inverse fast Fourier transform, addition of the guard interval, generation of a baseband digital signal, conversion to an analog signal, quadrature modulation, up-conversion, removal of an unnecessary frequency component, and amplification of power. A signal generated by the transmission processing unit 412 is transmitted from the antenna 413. Here, the radio transmission unit 412d may perform beamforming transmission using a plurality of antennas 413.

The storage unit 42 is a data readable/writable storage device such as DRAM, SRAM, a flash memory, or a hard disk. The storage unit 42 functions as storage means of the terminal device 40. Furthermore, the storage unit 42 may have a function of a Subscriber Identity Module (SIM), for example, a function for identifying a service subscriber that is called embedded SIM (eSIM) or integrate SIM, the integrate SIM being configured inside SoC.

The network communication unit 43 is a communication interface for communicating with other devices. For example, the network communication unit 43 includes a LAN interface such as NIC. The network communication unit 43 has a function for direct or indirect connection to a network N1. The network communication unit 43 may be a wired interface or a wireless interface. The network communication unit 43 functions as network communication means of the terminal device 40. The network communication unit 43 communicates with the other devices according to the control of the control unit 45.

The input/output unit 44 is a user interface for exchanging information with the user. For example, the input/output unit 44 is an operation device, such as a keyboard, mouse, operation keys, game controller, touch panel, voice input, or gesture input, through which various operations are performed by the user. Alternately, the input/output unit 44 is a display device such as Liquid Crystal Display or Organic Electroluminescence (EL) Display. The input/output unit 44 may be an acoustic device such as a speaker or buzzer. The input/output unit 44 may be a lighting device such as a Light Emitting Diode (LED) lamp. The input/output unit 44 functions as input/output means (input means, output means, operation means, or notification means) of the terminal device 40.

The control unit 45 is a controller that controls each unit of the terminal device 40. The control unit 45 is implemented by a processor such as CPU or MPU. For example, the control unit 45 is implemented by performing various programs stored in the storage device inside the terminal device 40 by the processor, with the RAM or the like as a working area. The control unit 45 may be implemented by an integrated circuit such as ASIC or FPGA. The CPU, MPU, ASIC, and FPGA can all be regarded as the controllers.

The control unit 45 includes a reservation selection unit 451, a registration processing unit 452, an operating environment acquisition unit 453, a use selection unit 454, and a connection processing unit 455.

The reservation selection unit 451 selects a service desired to be registered (reserved for use) from one or more services provided through the base station apparatus 20. The registration processing unit 452 performs the registration process for registration on the Serving PLMN via the base station apparatus 20. The registration processing unit 452 transmits, to the first management device 10A, the registration request message including information about the service selected by the reservation selection unit 451, and starts the registration process. Note that the registration process will be described in detail later.

The operating environment acquisition unit 453 acquires the environmental information about the operating environment of the terminal device 40. An example of the operating environment includes the mobility state which has been described above. In addition, the operating environment may include the number of beams simultaneously receivable, the number of antenna panels, the number of antenna layers, the number of Transmission and Reception Points (TRPs) that enables simultaneous reception, UE Capability, or UE Category. Furthermore, the operating environment may include the presence or absence of a sensor provided in the terminal device 40.

The operating environment acquisition unit 453 acquires, for example, the mobility state as the environmental information about the operating environment. The operating environment acquisition unit 453 acquires, as the mobility state, a dynamic change on the time axis of received power of a specific signal. The specific signal is, for example, a Primary Synchronization Signal (PSS), a Secondary Synchronization Signal (SSS), or a DeModulation Reference Signal (DMRS) of a Physical Broadcast Channel (PBCH), included in a Synchronization Signal Block (SSB). Furthermore, the dynamic change of the received power on the time axis is, for example, the magnitude of dispersion. The operating environment acquisition unit 453 calculates a dynamic change, and determines that the mobility state is large (high) when the calculated dynamic change is large, and determines that the mobility state is small (low) when the calculated dynamic change is small.

Furthermore, the operating environment acquisition unit 453 may determine the mobility state according to a change in position information about the terminal device 40 measured at a plurality of time points by using a position measurement function provided in the terminal device 40. The operating environment acquisition unit 453 determines that the mobility state is large (high) when the change in position information is large, and determines that the mobility state is small (low) when the change in position information is small.

The position measurement function provided in the terminal device 40 may be a Global Navigation Satellite System (GNSS) receiver represented by Global Positioning System (GPS) mounted on the terminal device 40. Alternatively, the position measurement function may be an arithmetic processing function of calculating the current position of the terminal device 40, on the basis of relative reception timing, received power, direction of arrival, and the like of position measurement reference signals received from a plurality of cellular base station apparatuses or a plurality of hot spots by the terminal device 40. Here, the direction of arrival may be measured by identifying a specific beam, for example, a beam having the largest received power, from among a plurality of beams transmitted from the cellular base station apparatuses or the hot spots.

Furthermore, the operating environment acquisition unit 453 may determine the mobility state according to the frequency of cell reselection or handover of the terminal device 40. The operating environment acquisition unit 453 determines that the mobility state is large (high) when the frequency of cell reselection is large, and determines that the mobility state is small (low) when the frequency of cell reselection is small.

Furthermore, in a case where the mobility state includes the motion state of the terminal device 40, the operating environment acquisition unit 453 determines the motion state of (the user who uses) the terminal device 40 by using the activity recognition function provided in the terminal device 40. The activity recognition function of the terminal device 40 may be, for example, an activity recognition function using AI, such as a neural network model in which information or values of various sensors is input and an action of the user is output. Here, the neural network model is a model generated as a result of, for example, Machine Learning (ML) or Deep Learning (DL).

In this case, the activity recognition function uses, as information or values of various sensors, all or some of values detected by a GNSS sensor, magnetic sensor, acceleration sensor, gyro sensor, luminance sensor (ambient light sensor), a proximity sensor, a fingerprint sensor, and an atmospheric pressure sensor to identify, for example, the action of the user. Note that the various sensors are not limited to the examples described above. The operating environment acquisition unit 453 may acquire the motion state of the user by using a value of a sensor other than the above sensors, as long as the sensor can be mounted on the terminal device 40.

Furthermore, the activity recognition function may identify the action of the user by using information acquired via a transmission/reception device compatible with 4G Long Term Evolution (LTE) and 5G, in addition to information from various sensors. Examples of such information are listed below.
RSRP (Reference Signal Received)
RSRQ (Reference Signal Received Quality)
RRC (Radio Resource Control) state
PCI (Physical Cell Identifier)
TAC (Tracking Area Code)
RANAC (RAN-based Notification Area Code)
NCGI (NR Cell Global Identifier)
Cell Identity, SSB (Synchronization signal and PBCH block)

Note that although the terminal device 40 is provided with the activity recognition function here, the present invention is not limited thereto. For example, the activity recognition function may be implemented in the network function such as the AMF, SMF, or DN. Alternatively, the activity recognition function may be implemented as one Network Function (NF). The terminal device 40 provides information necessary for the activity recognition function to identify the action of the user, for example, information from various sensors mounted on the terminal device 40, to the activity recognition function on the network via the base station apparatus 20. In addition, the operating environment acquisition unit 453 of the terminal device 40 acquires a result of activity recognition as the mobility state, from the activity recognition function on the network side via the base station apparatus 20.

The use selection unit 454 determines whether the use condition (reference information) of the service to which a use request is satisfied, on the basis of the environmental information about the operating environment acquired by the operating environment acquisition unit 453. For example, in a case where the terminal device 40 receives provision a predetermined service, the use selection unit 454 determines whether the operating environment of the terminal device 40 satisfies the use condition. Therefore, the use selection unit 454 can suppress the use request for the predetermined service from the terminal device 40 that is unsuitable for providing the service.

The connection processing unit 455 performs the connection process including the use request for the service determined by the use selection unit 454 to satisfy the use condition of the service. Note that the connection process will be described in detail later.

The connection processing unit 455 transmits a connection request message including the information about the operating environment acquired by the operating environment acquisition unit 453 to start the connection process. At this time, the connection processing unit 455 may add the environmental information (e.g., mobility low) used for determination of the use by the use selection unit 454 to the connection request message, or may add, for example, raw data such as sensor output data (e.g., an output value from the GPS). As described above, the environmental information included in the connection request message may be any information as long as the first management device 10A can determine the permission of use of the service, and the format of the data is not particularly limited. In addition, the format or form of the environmental information included in the connection request message may be set in advance, for example, from the first management device 10A in the registration process.

### 3. Operations of Communication System

<3.1. Registration Process>

The terminal device 40 performs the registration process for registration on the Serving PLMN, for example, when power is turned on (activated). Here, such registration process will be described first.

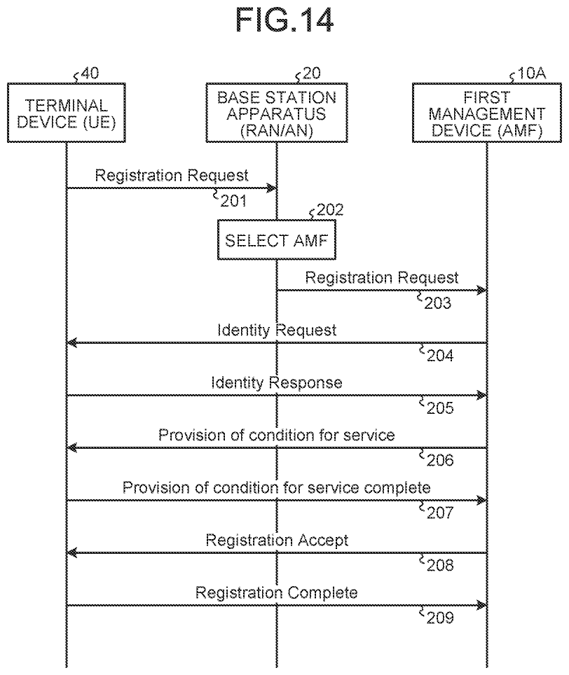

FIG. 14 is a sequence diagram illustrating a procedure of the registration process according to the embodiment of the present disclosure. When receiving the service via the NSI, the terminal device 40 performs the registration process (RM procedure) illustrated in FIG. 14.

First, the terminal device 40 transmits the Registration Request including at least Requested NSSAI to the base station apparatus 20 (RAN/AN) (Step S201). The terminal device 40 selects the S-NSSAI corresponding to the network slice desired to be registered, for example, from among S-NSSAIs included in the Configured NSSAI. The terminal device 40 adds the Requested NSSAI including the selected S-NSSAI to the Registration Request and transmits the Registration Request. More specifically, the terminal device 40 transmits the AN message including the Registration Request and the AN parameters to the base station apparatus 20. The AN parameters include the Requested NSSAI. The Requested NSSAI included in the AN parameters is used for selection of the AMF (first management device 10A) by the base station apparatus 20.

Here, when performing Initial Registration (registration process), the terminal device 40 notifies of information for identifying the terminal device 40 with a Registration Request message. At that time, a Subscription Concealed Identifier (SUCI) or 5G Globally Unique Temporary UE Identity (5G-GUTI) is used.

When the terminal device 40 has a valid Evolved Packet System (EPS) GUTI, the terminal device 40 uses the 5G-GUTI assigned from the EPS GUTI.

Alternatively the terminal device 40 uses, if available, the 5G-GUTI assigned from the Public Land Mobile Network (PLMN) to which registration is attempted.

Alternatively the terminal device 40 uses, if available, the 5G-GUTI assigned from PLMN equivalent to the PLMN to which registration is attempted.

Alternatively the terminal device 40 uses, if available, the 5G-GUTI assigned from any PLMN.

Otherwise, the terminal device 40 adds the SUCI to the Registration Request.

The base station apparatus 20 (RAN/AN) selects the AMF (first management device 10A) on the basis of the Requested NSSAI acquired from the terminal device 40 (Step S202). The base station apparatus 20 (RAN/AN) selects the AMF (first management device 10A), on the basis of the Requested NSSAI included in the AN parameters of the AN message. The base station apparatus 20 (RAN/AN) transmits the Registration Request made by the terminal device 40 to the selected first management device 10A (Step S203). If the base station apparatus 20 (RAN/AN) cannot select the AMF (the first management device 10A) on the basis of the Requested NSSAI, the request is transferred to a default AMF.

When the SUCI is not provided from the terminal device 40, the first management device 10A (AMF) transmits an Identity Request to the terminal device 40 via the base station apparatus (RAN/AN) with an NAS message (Step S204).

The terminal device 40 having received the Identity Request in Step S204 responds to the first management device 10A (AMF) with an Identity Response including SUCI (Step S205). Here, the terminal device 40 uses a public key provided from a Home PLMN (HPLMN) to generate the SUCI from a Subscription Permanent Identifier (SUPI) stored in a Subscriber Identity Module (SIM) Card.

The first management device 10A (AMF) refers to the Subscribed S-NSSAI that is the subscription information, selects an allowable S-NSSAI from among the S-NSSAIs included in the Requested NSSAI, and generates the Allowed NSSAI including the selected S-NSSAI.

At this time, the first management device 10A (AMF) acquires the reference information about the operating environment of the terminal device 40, from the storage unit 12A, as the condition for using the service corresponding to the Requested NSSAI, more specifically, a service corresponding to Allowed NSSAI. The first management device 10A (AMF) provides the acquired reference information to the terminal device 40, as Provision of condition for service (Step S206). The terminal device 40 responds with Provision of condition for service complete (Step S207). Here, the first management device 10A (AMF) sets the condition (reference information) for using this service (Allowed NSSAI), for each service (for each S-NSSAI).

The first management device 10A (AMF) transmits Registration Accept to the terminal device 40 (Step S208), and the terminal device 40 responds with Registration Complete to the first management device 10A (AMF) (Step S209), and the registration process of the terminal device 40 is completed.

<3.2. PDU Session Establishment Process>

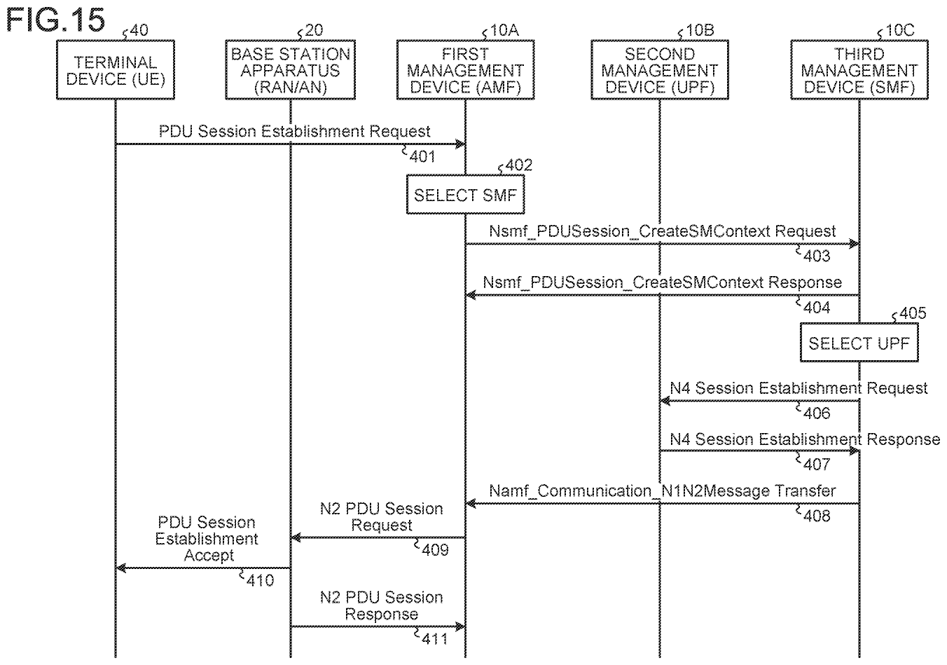

The terminal device 40 that has completed the registration process establishes the PDU session with the DN to perform data communication using the NSI. Next, a PDU session establishment process will be described with reference to FIGS. 15 to 17. Here, one PDU session is associated with one S-NSSAI and one DNN. In other words, in a case where a plurality of S-NSSAIs or a plurality of DNNs is handled in one application, a plurality of PDU sessions corresponding to the respective S-NSSAIs or the respective DNNs is established.

The terminal device 40 that has completed the registration process of FIG. 14 performs the PDU session establishment process illustrated in FIG. 15 upon receiving the service via the NSI.

FIG. 15 is a sequence diagram illustrating an example of the PDU session establishment process in the communication system of the present disclosure.

The terminal device 40 transmits a PDU Session Establishment Request to the first management device 10A (AMF) via the base station apparatus 20 (RAN/AN) (Step S401). Here, the terminal device 40 adds the following three pieces of information to the PDU Session Establishment Request.

(1) The S-NSSAI corresponding to the desired service

(2) The DNN requested by the terminal device 40

(3) Information about a condition for using the S-NSSAI in (1) (environmental information about the operating environment of the terminal device 40)

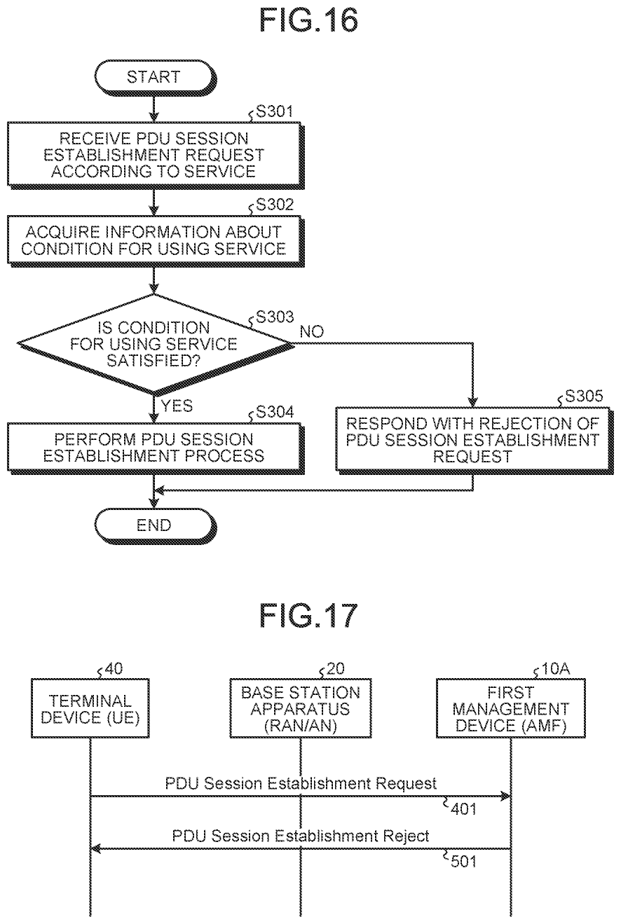

In Step S401, the first management device 10A (AMF) that has received the PDU Session Establishment Request determines whether to allow or reject the PDU session establishment request on the basis of the environmental information about the operating environment of the terminal device 40. More specifically, the first management device 10A (AMF) performs a PDU session establishment determination process illustrated in FIG. 16. Note that FIG. 16 is a flowchart illustrating an example of the establishment determination process in the first management device 10A (AMF) according to the embodiment of the present disclosure.

As illustrated in FIG. 16, when receiving the PDU session establishment request according to the desired service from the terminal device 40 (Step S301), the first management device 10A (AMF) acquires the information about the operating environment of the terminal device 40, as the condition for using the service included in the PDU session establishment request (Step S302).

The first management device 10A (AMF) determines whether the terminal device 40 satisfies the condition for using the desired service (Step S303). When it is determined that the terminal device 40 satisfies the condition for using the desired service, the first management device 10A (AMF) performs the PDU session establishment processing corresponding to the desired service (Step S304).

On the other hand, when it is determined, in Step S303, that the terminal device 40 does not satisfy the condition for using the desired service, the first management device 10A (AMF) responds to the terminal device 40 with rejection of the PDU session establishment request (Step S305).

Note that the first management device 10A (AMF) may be provided with a function of predicting a future operating environment of the terminal device 40, for example, a prediction function using the Artificial Intelligence (AI). Here, the prediction function using the AI is, for example, a prediction function using a neural network model generated by machine learning (ML) or deep learning (DL). In this configuration, the terminal device 40 may add information (e.g., history information related to a history of the operating environment of the terminal device 40) used for prediction of the future operating environment of the terminal device 40 to the PDU Session Establishment Request transmitted in Step S301.

In other words, the first management device 10A (AMF) may determine whether the terminal device 40 satisfies the condition for using the desired service in consideration of the future operating environment of the terminal device 40. This means that when determining that the terminal device 40 satisfies the use condition of the desired service at present and in the future (for a predetermined period from the present), the first management device 10A (AMF) permits the use of the service. On the other hand, when it is determined that the terminal device 40 may not satisfy the use condition of the desired service at present or in the future, the first management device 10A (AMF) rejects to use the service.

Here, information related to setting of the granularity, the period, and the like of the information (e.g., history information related to a history of the operating environment of the terminal device 40) used for prediction of the future operating environment of the terminal device 40 is provided as the Provision of condition for service (not illustrated) from the first management device 10A (AMF) in the registration process illustrated in FIG. 14.

Returning to FIG. 15, the example the PDU session establishment process will be continued again. Here, the following processing will be described on the assumption that the first management device 10A (AMF) determines to allow the PDU session establishment request in Step S303 of FIG. 16.

When the PDU session establishment request is allowed on the basis of the environmental information about the operating environment of the terminal device 40, the first management device 10A (AMF) performs selection of the SMF (third management device 10C) on the basis of the acquired S-NSSAI (Step S402).

The first management device 10A (AMF) transmits Nsmf_PDUSession_CreateSMContext Request to the third management device 10C (SMF) selected in Step S402 (Step S403).

In Step S403, the third management device 10C (SMF) that has received the Nsmf_PDUSession_CreateSMContext Request determines whether the PDU Session Establishment Request can be processed. When the PDU Session Establishment Request can be processed, the third management device 10C (SMF) generates SM context and responds to the first management device 10A (AMF) with Nsmf_PDUSession_CreateSMContext Response including a SM Context ID (Step S404).

Subsequently, the third management device 10C (SMF) selects the UPF (second management device 10B) on the basis of the S-NSSAI and the DNN acquired via the Nsmf_PDUSession_CreateSMContext Request in Step S403 (Step S405). Furthermore, the third management device 10C (SMF) triggers N4 Session Establishment procedure to the selected second management device 10B (UPF), and transmits the N4 Session Establishment Request to the second management device 10B (UPF) (Step S406).

When accepting the N4 session establishment request, the second management device 10B (UPF) responds with N4 Session Establishment Response (Step S407).

The third management device 10C (SMF) transmits Namf_Communication_N1N2MessageTransfer including a PDU Session ID and PDU Session Establishment Accept to the first management device 10A (AMF) (Step S408).

The first management device 10A (AMF) transmits the N2 PDU Session Request that is the Non Access Stratum (NAS) message including the PDU Session ID and the PDU Session Establishment Accept, to the base station apparatus 20 (RAN/AN) (Step S409).

The base station apparatus 20 (RAN/AN) transfers the NAS message including the PDU Session ID and the PDU Session Establishment Accept, acquired via the N2 PDU Session Request, to the terminal device 40 (Step S410).

When accepting the N2 PDU session establishment request, the base station apparatus 20 (RAN/AN) responds to the first management device 10A (AMF) with N2 PDU Session Response (Step S411).

Upon completion of the above process, the terminal device 40 is allowed to receive the service via the NSI during the established PDU session.

Hereinafter, another example of the PDU session establishment process according to the embodiment of the present disclosure will be described with reference to FIG. 17. FIG. 17 is a sequence diagram illustrating another example of the PDU session establishment process according to the embodiment of the present disclosure.

In the sequence illustrated in FIG. 15, allowing the PDU session establishment request has been described. On the other hand, for example, when the operating environment of the terminal device 40 does not satisfy the condition for using the desired service, the first management device 10A (AMF) rejects the use of the service (PDU session establishment request). In FIG. 17, rejection of the use of the service (PDU session establishment request) by the first management device 10A (AMF) will be described. Note that a sequence from the transmission of the PDU Session Establishment Request by the terminal device 40 to the establishment determination process by the first management device 10A (AMF) illustrated in FIG. 16 is the same as the sequence illustrated in FIG. 15.

When rejection of the PDU session establishment request is determined in Step S303 of FIG. 16, the first management device 10A (AMF) responds to the terminal device 40 with the NAS message including PDU Session Establishment Reject via the base station apparatus 20 (RAN/AN), as illustrated in FIG. 17 (Step S501).

As described above, depending on the situation of the operating environment of the terminal device 40, the PDU session corresponding to the desired service cannot be established, and thus, the service via the NSI cannot be received.

As described above, even when the terminal device 40 has the subscription for using the desired service, the first management device 10A rejects use of the service, when the operating environment does not satisfy the use condition of the service. In other words, when the operating environment satisfies the use condition of the service, the first management device 10A provides the desired service to the terminal device 40.

As described above, for example, when a service is wirelessly provided to a game device, considerably different characteristics are required for radio communication depending on the type of the game, and there is a problem that it is difficult to provide the service with adequate quality, depending on the reception environment or mobility state of the game device.

As described above, according to the present embodiment, the allowance or rejection of the connection request is determined, in consideration of not only the subscription information but also the operating environment of the wireless communication terminal (terminal device 40), for example, the reception environment or the mobility state, in the mechanism of the network slicing. Therefore, the stable quality service can be provided, to a wireless communication device that is suitable for each service. Furthermore, restriction of provision of the service to a wireless communication device unsuitable for the service makes it possible to ensure isolation between slices, which is an important problem in the concept of network slicing.

Furthermore, in the registration process, notifying the wireless communication device of the operating environment of the wireless communication device required for each slice of the network slices in advance makes it possible to suppress an unnecessary connection request from the wireless communication device unsuitable for the service.

Therefore, the communication system can provide a more stable quality service.

### 4. Other Embodiments

The embodiments described above are merely examples, and various modifications and applications are possible.

In the above embodiments, the terminal device 40 transmits the registration request to the specific base station apparatus 20, but the present invention is not limited thereto. A base station apparatus 20 to which connection is to be made may be identified from among a plurality of base station apparatuses 20, on the basis of information about the network slices supported by the plurality of base station apparatuses 20 to transmit the registration request. Alternatively, the terminal device 40 may identify a base station apparatus 20 to which connection is to be made, from among the plurality of base station apparatuses 20, on the basis of information about a communication service supported by each of the plurality of base station apparatuses 20. At this time, the information about a communication service may be information indicating any of a plurality of communication services of different communication forms. At this time, the plurality of communication services may include at least two communication services selected from mMTC, eMBB, and URLLC.

In the above embodiment, the fifth generation mobile communication system (5G) has been described as an example of the communication system, but the present invention is not limited thereto. For example, a network architecture other than 5G such as LTE may be employed as an example of the communication system. In this case, the first management device 10A that implements the function of AMF and the third management device 10C that implements the function of SMF may be one management device (device that implements the function of EMM).

A control device that controls the first to third management devices 10A to 10C, the base station apparatus 20, or the terminal device 40 according to the present embodiment may be implemented by a dedicated computer system or a general-purpose computer system.

For example, programs for executing the operations described above are stored in a computer-readable recording medium such as an optical disk, semiconductor memory, magnetic tape, or flexible disk, for distribution. Then, for example, the programs are installed on the computer to perform the processes described above, and the control device is configured. At this time, the control device may be a device (e.g., a personal computer) outside the first to third management devices 10A to 10C, base station apparatus 20, or terminal device 40. Furthermore, the control device may be a device (e.g., the control units 13A to 13C, the control unit 24, or the control unit 45) inside the first to third management devices 10A to 10C, base station apparatus 20, or terminal device 40.

Furthermore, programs for the communication described above may be stored in a disk device of a server device on a network such as the Internet so as to be downloaded to the computer. Furthermore, the functions described above may be implemented by cooperation between an Operating System (OS) and application software. In this configuration, a portion other than the OS may be stored in a medium so as to be distributed, or the portion other than the OS may be stored in the server device, for example, so as to be downloaded to the computer.

Furthermore, of the processes described in the above embodiments, all or some of processes described to be performed automatically may be performed manually, or all or some of processes described to be performed manually may be performed automatically by a known method. In addition, the processing procedures, specific names, and information including various data and parameters, which are described in the above description or illustrated in the drawings can be appropriately changed unless otherwise specified. For example, the various types of information illustrated in the drawings are not limited to the illustrated information.

Furthermore, the component elements of the devices are illustrated as functional concepts and are not necessarily required to be physically configured as illustrated. In other words, specific forms of distribution or integration of the devices are not limited to those illustrated, and all or some of the devices may be configured by being functionally or physically distributed or integrated in appropriate units, according to various loads or usage conditions.

Furthermore, the embodiments described above can be appropriately combined within a range consistent with the contents of the processing. Furthermore, the orders of the steps illustrated in the sequence diagrams or the flowchart of the present embodiment can be changed appropriately.

Furthermore, for example, the present embodiment can be implemented as all configurations constituting a device or a system, such as a processor as a system Large Scale Integration (LSI) or the like, a module using a plurality of processors or the like, a unit using a plurality of modules or the like, and a set (i.e., a configuration of part of the device) obtained by further adding other functions to the unit.

Note that, in the present embodiment, the system means an aggregation of a plurality of component elements (devices, modules (parts), etc.), and it does not matter whether all the component elements are in the same housing. Therefore, a plurality of devices that is housed in separate housings and connected via a network, and one device in which a plurality of modules is housed in one housing are both systems.

Furthermore, for example, the present embodiment can adopt a configuration of cloud computing in which one function is shared between a plurality of devices via a network to perform processing by the plurality of devices in cooperation.

### 5. Supplementary Notes

Preferred embodiments of the present disclosure have been described above in detail with reference to the accompanying drawings, but the technical scope of the present disclosure is not limited to these examples. A person skilled in the art may obviously find various alternations and modifications within the technical concept described in claims, and it should be understood that the alternations and modifications will naturally come under the technical scope of the present disclosure.

Furthermore, the effects descried herein are merely explanatory or exemplary effects, and not limitative. In other words, the technology according to the present disclosure can achieve other effects that are apparent to those skilled in the art from the description herein, along with or instead of the above effects.

Note that the present technology can also employ the following configurations.

(1)

A terminal device comprising

a control unit

acquiring service information about one or more services provided via a base station apparatus;

selecting at least one service desired to be used, from among the one or more services;

transmitting a registration request message including the service selected, to a management device managing mobility of the terminal device via the base station apparatus; and

receiving, for each of the services included in the registration request message, reference information about an operating environment of the terminal device requested upon using the service.

(2)

The terminal device according to (1), wherein

the control unit

acquires environmental information about the operating environment of the terminal device,

selects the service in which the environmental information satisfies the reference information, from among the services desired to be used, and

makes a request for use of the service selected.

(3)

The terminal device according to (2), wherein when requesting use of the service, the control unit transmits a connection request message including the environmental information, to the management device.

(4)

The terminal device according to (3), wherein a process of making the request for use of the service includes Packet Data Unit (PDU) session establishment processing.

(5)

The terminal device according to any one of (1) to (4), wherein the reference information about the operating environment is information about a reception state of the terminal device.

(6)

The terminal device according to (5), wherein the information about the reception state represents a power value obtained by averaging received power of a predetermined reference signal received during a predetermined period.

(7)

The terminal device according to any one of (1) to (6), wherein the reference information about the operating environment represents a mobility state of the terminal device.

(8)

The terminal device according to (7), wherein

the control unit

acquires position information that is a result of position measurement for the terminal device at a plurality of time points, and

calculates the mobility state of the terminal device based on the position information.

(9)

The terminal device according to any one of (1) to (8), wherein the reference information about the operating environment is information about the number of beams simultaneously receivable when the base station apparatus transmits multiple beams.

(10)

The terminal device according to any one of (1) to (9), wherein the reference information about the operating environment is information about the number of Transmission and Reception Points (TRPs) that enables simultaneous reception when the base station apparatus transmits multi-TRPs.

(11)

The terminal device according to any one of (1) to (10), wherein the reference information about the operating environment is information about whether a predetermined sensor is provided.

(12)

A management device managing mobility of a terminal device, the management device comprising

a control unit

receiving a registration request message including at least one service desired to be used by the terminal device, selected from among one or more services provided via a base station apparatus, from the terminal device via the base station apparatus; and

transmitting, to the terminal device via the base station apparatus, reference information about an operating environment of the terminal device requested upon using the service, for each of the services included in the registration request message.

(13)

The management device according to (12), wherein

the control unit

when a connection request message including a use request for the service and environmental information about the operating environment of the terminal device is received from the terminal device via the base station apparatus, determines whether to permit the use of the service, based on whether the environmental information satisfies the reference information.

(14)

A communication method comprising:

acquiring service information about one or more services provided via a base station apparatus;

selecting at least one service desired to be used, from among the one or more services;

transmitting a registration request message including the service selected, to a management device managing mobility of a terminal device via the base station apparatus; and

receiving, for each of the services included in the registration request message, reference information about an operating environment of the terminal device requested upon using the service.

(15)

A communication method by a management device managing mobility of a terminal device, the management device comprising:

receiving a registration request message including at least one service desired to be used by the terminal device, selected from among one or more services provided via a base station apparatus, from the terminal device via the base station apparatus; and

transmitting, to the terminal device via the base station apparatus, reference information about an operating environment of the terminal device requested upon using the service, for each of the services included in the registration request message.

### REFERENCE SIGNS LIST

10 MANAGEMENT DEVICE
11 COMMUNICATION UNIT
12, 22, 42 STORAGE UNIT
13, 24, 45 CONTROL UNIT
20 BASE STATION APPARATUS
21, 41 WIRELESS COMMUNICATION UNIT
23, 43 NETWORK COMMUNICATION UNIT
40 TERMINAL DEVICE
44 INPUT/OUTPUT UNIT

1. A terminal device comprising
a control unit
acquiring service information about one or more services provided via a base station apparatus;
selecting at least one service desired to be used, from among the one or more services;
transmitting a registration request message including the service selected, to a management device managing mobility of the terminal device via the base station apparatus; and
receiving, for each of the services included in the registration request message, reference information about an operating environment of the terminal device requested upon using the service.

2. The terminal device according to claim 1, wherein
the control unit
acquires environmental information about the operating environment of the terminal device,
selects the service in which the environmental information satisfies the reference information, from among the services desired to be used, and
makes a request for use of the service selected.

3. The terminal device according to claim 2, wherein when requesting use of the service, the control unit transmits a connection request message including the environmental information, to the management device.

4. The terminal device according to claim 3, wherein a process of making the request for use of the service includes Packet Data Unit (PDU) session establishment processing.

5. The terminal device according to claim 1, wherein the reference information about the operating environment is information about a reception state of the terminal device.

6. The terminal device according to claim 5, wherein the information about the reception state represents a power value obtained by averaging received power of a predetermined reference signal received during a predetermined period.

7. The terminal device according to claim 1, wherein the reference information about the operating environment represents a mobility state of the terminal device.

8. The terminal device according to claim 7, wherein
the control unit
acquires position information that is a result of position measurement for the terminal device at a plurality of time points, and
calculates the mobility state of the terminal device based on the position information.

9. The terminal device according to claim 1, wherein the reference information about the operating environment is information about the number of beams simultaneously receivable when the base station apparatus transmits multiple beams.

10. The terminal device according to claim 1, wherein the reference information about the operating environment is information about the number of Transmission and Reception Points (TRPs) that enables simultaneous reception when the base station apparatus transmits multi-TRPs.

11. The terminal device according to claim 1, wherein the reference information about the operating environment is information about whether a predetermined sensor is provided.

12. A management device managing mobility of a terminal device, the management device comprising
a control unit
receiving a registration request message including at least one service desired to be used by the terminal device, selected from among one or more services provided via a base station apparatus, from the terminal device via the base station apparatus; and
transmitting, to the terminal device via the base station apparatus, reference information about an operating environment of the terminal device requested upon using the service, for each of the services included in the registration request message.

13. The management device according to claim 12, wherein
the control unit
when a connection request message including a use request for the service and environmental information about the operating environment of the terminal device is received from the terminal device via the base station apparatus, determines whether to permit the use of the service, based on whether the environmental information satisfies the reference information.

14. A communication method comprising:
acquiring service information about one or more services provided via a base station apparatus;
selecting at least one service desired to be used, from among the one or more services;
transmitting a registration request message including the service selected, to a management device managing mobility of a terminal device via the base station apparatus; and
receiving, for each of the services included in the registration request message, reference information about an operating environment of the terminal device requested upon using the service.

15. A communication method by a management device managing mobility of a terminal device, the management device comprising:
receiving a registration request message including at least one service desired to be used by the terminal device, selected from among one or more services provided via a base station apparatus, from the terminal device via the base station apparatus; and
transmitting, to the terminal device via the base station apparatus, reference information about an operating environment of the terminal device requested upon using the service, for each of the services included in the registration request message.
